(19) United States
(12) Patent Application Publication
(10) Pub. No.: US 2026/0197819 A1
(43) Pub. Date: Jul. 9, 2026

(54) CONTINUOUS RATE MATCHING FOR HYBRID AUTOMATIC REPEAT REQUEST RETRANSMISSION

(71) Applicant: QUALCOMM Incorporated, San Diego, CA (US)

(72) Inventors: Morteza SOLTANI, San Diego, CA (US); Mostafa KHOSHNEVISAN, San Diego, CA (US); Jing SUN, San Diego, CA (US)

(21) Appl. No.: 19/014,951

(22) Filed: Jan. 9, 2025

(51) Int. Cl. H04W 72/1263; H04L 1/1812

(52) U.S. Cl. CPC H04W 72/1263; H04L 1/1812

(57) ABSTRACT

Various aspects of the present disclosure generally relate to wireless communication. In some aspects, a user equipment (UE) may receive, from a network node, first control information that schedules an initial transmission of a transport block associated with a hybrid automatic repeat request (HARQ) process. The UE may receive, from the network node, second control information that schedules a retransmission of the transport block based on the initial transmission of the transport block being associated with a HARQ negative acknowledgement (NACK) indication. The UE may communicate, with the network node, the retransmission of the transport block in accordance with a continuous rate matching mode based on one or more conditions. Numerous other aspects are described.

### FIELD OF THE DISCLOSURE

Aspects of the present disclosure generally relate to wireless communication and specifically relate to techniques, apparatuses, and methods associated with continuous rate matching for hybrid automatic repeat request (HARQ) retransmission.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Hybrid automatic repeat request (HARQ) is a mechanism in wireless communication systems that enables reliable data transmission between a transmitting device and a receiving device. HARQ combines forward error correction (FEC) with retransmissions to address errors caused by noise, interference, or channel conditions below a quality threshold. If the transmitting device transmits a data block, the receiving device may attempt to decode the data block. Additionally, the receiving device may respond to the transmitting device with an acknowledgment (ACK) if decoding the data block is successful or a negative acknowledgment (NACK) if decoding the data block is unsuccessful. In accordance with receiving a NACK, the transmitting device may retransmit the data block using incremental redundancy, where each retransmission provides additional redundant bits to enhance error correction at the receiving device. The receiving device may combine information from multiple transmissions using soft-combining, which may increase the likelihood of successful decoding.

### SUMMARY

Some aspects described herein relate to a user equipment (UE) for wireless communication. The UE may include one or more memories and one or more processors coupled to the one or more memories. The one or more processors may be configured to receive, from a network node, first control information that schedules an initial transmission of a transport block associated with a hybrid automatic repeat request (HARQ) process. The one or more processors may be configured to receive, from the network node, second control information that schedules a retransmission of the transport block based at least in part on the initial transmission of the transport block being associated with a HARQ negative acknowledgement (NACK) indication. The one or more processors may be configured to communicate, with the network node, the retransmission of the transport block in accordance with a continuous rate matching mode based at least in part on one or more conditions.

Some aspects described herein relate to a network node for wireless communication. The network node may include one or more memories and one or more processors coupled to the one or more memories. The one or more processors may be configured to transmit, to a UE, first control information that schedules an initial transmission of a transport block associated with a HARQ process. The one or more processors may be configured to transmit, to the UE, second control information that schedules a retransmission of the transport block based at least in part on the initial transmission of the transport block being associated with a HARQ NACK indication. The one or more processors may be configured to communicate, with the UE, the retransmission of the transport block in accordance with a continuous rate matching mode based at least in part on one or more conditions.

Some aspects described herein relate to a method of wireless communication performed by a UE. The method may include receiving, from a network node, first control information that schedules an initial transmission of a transport block associated with a HARQ process. The method may include receiving, from the network node, second control information that schedules a retransmission of the transport block based at least in part on the initial transmission of the transport block being associated with a HARQ NACK indication. The method may include communicating, with the network node, the retransmission of the transport block in accordance with a continuous rate matching mode based at least in part on one or more conditions.

Some aspects described herein relate to a method of wireless communication performed by a network node. The method may include transmitting, to a UE, first control information that schedules an initial transmission of a transport block associated with a HARQ process. The method may include transmitting, to the UE, second control information that schedules a retransmission of the transport block based at least in part on the initial transmission of the transport block being associated with a HARQ NACK indication. The method may include communicating, with the UE, the retransmission of the transport block in accordance with a continuous rate matching mode based at least in part on one or more conditions.

Some aspects described herein relate to a non-transitory computer-readable medium that stores a set of instructions for wireless communication by a UE. The set of instructions, when executed by one or more processors of the UE, may cause the UE to receive, from a network node, first control information that schedules an initial transmission of a transport block associated with a HARQ process. The set of instructions, when executed by one or more processors of the UE, may cause the UE to receive, from the network node, second control information that schedules a retransmission of the transport block based at least in part on the initial transmission of the transport block being associated with a HARQ NACK indication. The set of instructions, when executed by one or more processors of the UE, may cause the UE to communicate, with the network node, the retransmission of the transport block in accordance with a continuous rate matching mode based at least in part on one or more conditions.

Some aspects described herein relate to a non-transitory computer-readable medium that stores a set of instructions for wireless communication by a network node. The set of instructions, when executed by one or more processors of the network node, may cause the network node to transmit, to a UE, first control information that schedules an initial transmission of a transport block associated with a HARQ process. The set of instructions, when executed by one or more processors of the network node, may cause the network node to transmit, to the UE, second control information that schedules a retransmission of the transport block based at least in part on the initial transmission of the transport block being associated with a HARQ NACK indication. The set of instructions, when executed by one or more processors of the network node, may cause the network node to communicate, with the UE, the retransmission of the transport block in accordance with a continuous rate matching mode based at least in part on one or more conditions.

Some aspects described herein relate to an apparatus for wireless communication. The apparatus may include means for receiving, from a network node, first control information that schedules an initial transmission of a transport block associated with a HARQ process. The apparatus may include means for receiving, from the network node, second control information that schedules a retransmission of the transport block based at least in part on the initial transmission of the transport block being associated with a HARQ NACK indication. The apparatus may include means for communicating, with the network node, the retransmission of the transport block in accordance with a continuous rate matching mode based at least in part on one or more conditions.

Some aspects described herein relate to an apparatus for wireless communication. The apparatus may include means for transmitting, to a UE, first control information that schedules an initial transmission of a transport block associated with a HARQ process. The apparatus may include means for transmitting, to the UE, second control information that schedules a retransmission of the transport block based at least in part on the initial transmission of the transport block being associated with a HARQ NACK indication. The apparatus may include means for communicating, with the UE, the retransmission of the transport block in accordance with a continuous rate matching mode based at least in part on one or more conditions.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a hybrid automative repeat request (HARQ) process, in accordance with the present disclosure.

FIG. 4 is a diagram illustrating an example of HARQ redundancy techniques, in accordance with the present disclosure.

FIG. 5 is a diagram illustrating an example associated with continuous rate matching for HARQ retransmission, in accordance with the present disclosure.

FIGS. 6A and 6B are diagrams illustrating examples associated with indicating continuous rate matching for a HARQ process, in accordance with the present disclosure.

FIG. 7 is a diagram illustrating an example process performed, for example, at a user equipment (UE) or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples of wireless communications, one or more wireless devices may operate in accordance with a hybrid automatic repeat request (HARQ) process. For example, the HARQ process may involve coordinated transmissions and retransmissions between a user equipment (UE) and a network node to enable reliable data delivery. For uplink HARQ, the network node (e.g., receiving device) may schedule the UE (e.g., the transmitting device) with an uplink transmission of a transport block (TB) by assigning resources through downlink control information (DCI). Similarly, for downlink HARQ, the network node (e.g., transmitting device) schedules the UE (e.g., receiving device) to receive a downlink transmission of a downlink TB by assigning resources through DCI. Retransmissions of the TB may be triggered based on negative acknowledgments (NACKs). For example, in uplink, if the network node fails to decode the initial uplink transmission of the TB, then the network node may transmit a NACK to the UE. Similarly, in downlink, if the UE fails to decode the initial downlink transmission of the TB, then the UE may transmit a NACK to the network node. If a NACK is transmitted in accordance with the receiving device failing to decode the initial HARQ transmission, then the transmitting device may transmit a HARQ retransmission of the TB.

In some examples, respective HARQ transmissions/retransmissions of a TB may be in accordance with respective portions of a codeword associated with the TB. For instance, a codeword may be the encoded representation of the TB that may include original data bits and additional redundancy bits generated during channel coding. The codeword may be stored in a circular buffer of the transmitting device, which may enable flexible access to different portions of the codeword for transmission. Additionally, the receiving device may receive different portions of the codeword over different HARQ transmissions/retransmissions, and store the different portions of the codeword to a circular buffer at the receiving device. Additionally, the receiving device may perform one or more combining techniques (such as soft-combining) to combine the different portions of the codeword to decode the TB.

In some examples, transmitting different portions of the codeword across multiple transmissions/retransmissions may be associated with redundancy version (RV) identifiers (IDs) or continuous rate matching to improve decoding performance. For instance, RV IDs may correspond to predefined subsets of the codeword associated with storing to predefined portions of the circular buffer, which may provide incremental redundancy by transmitting different parts of the codeword across retransmissions. On the other hand, in accordance with continuous rate matching, each HARQ retransmission indicates a portion of the codeword that may be directly after the portion of the codeword indicated in the previous HARQ transmission/retransmission. Therefore, continuous rate matching may adapt the selection of bits more flexibly (compared to RV ID) based on a coding status of the receiving device, offering finer granularity and potentially higher coding gain by leveraging additional redundancy.

However, continuous rate matching may be ineffective if the UE fails to receive a DCI that schedules a HARQ transmission/retransmission. For example, in downlink, if the UE fails to receive a DCI that schedules the initial downlink HARQ transmission that includes a first portion of the codeword, then the UE may fail to receive the first portion of the codeword. Therefore, if the UE were to receive a first downlink HARQ retransmission that includes a second portion of the codeword, the UE may be unaware of where to store the second portion of the codeword because the UE may not know the length of the first portion of the codeword. In some examples, the network node may indicate, in each scheduling DCI, additional information associated with each transmitted portion of the codeword such that the UE can determine where to store each portion of the codeword in the circular buffer. However, such additional information may increase the signaling overhead associated with using continuous rate matching above the signaling overhead associated with using RV ID.

Various aspects relate generally to performing continuous rate matching for HARQ retransmission in accordance with an indication of a reserved modulation and coding scheme (MCS). For example, each scheduling DCI of a HARQ process may indicate an explicit MCS (e.g., that indicates both a modulation order and a coding rate) or a reserved MCS (e.g., that explicitly indicates the modulation order, but does not indicate the coding rate). Additionally, the network node may be enabled to indicate reserved MCS only if the initial DCI that schedules the first HARQ transmission is successfully received by the UE. Therefore, in cases where the reserved MCS is indicated, the network node may be aware that the UE received the initial DCI, and accordingly, the UE may be able to operate in accordance with continuous rate matching. Therefore, the UE may be configured to operate in accordance with continuous rate matching for a HARQ retransmission, if the DCI scheduling the HARQ retransmission indicates reserved MCS. In addition to indicating reserved MCS, the scheduling DCI may further include a field that indicates whether continuous rate matching is enabled or whether RV ID is enabled. Therefore, the network node and UE may dynamically fall back from continuous rate matching to RV ID during the HARQ process based on one or more conditions described elsewhere herein.

Particular aspects of the subject matter described in this disclosure can be implemented to realize one or more of the following potential advantages. In some examples, the described techniques can be used to increase coding gain of a HARQ process associated with continuous rate matching while maintaining reliability of the HARQ process. For example, by associating the use of continuous rate matching with the indication of reserved MCS, the network node may indicate the use of continuous rate matching in cases where the UE successfully receives a preceding scheduling DCI, and therefore may be able to leverage the increased coding gain associated with continuous rate matching. Additionally, the described techniques may enable falling back from continuous rate matching to RV ID. For example, if the UE misses a scheduling DCI for a HARQ transmission/retransmission, the network node may dynamically indicate in the next scheduling DCI to switch to using RV ID for the HARQ process. Such dynamic fall back to RV ID may enable the HARQ process to leverage the techniques of RV ID in cases where continuous rate matching may be ineffective due to a lack of information at the UE. Therefore, dynamic fall back may enable the network node and UE to leverage both the coding gain associated with continuous rate matching, and an increased reliability associated with RV ID.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

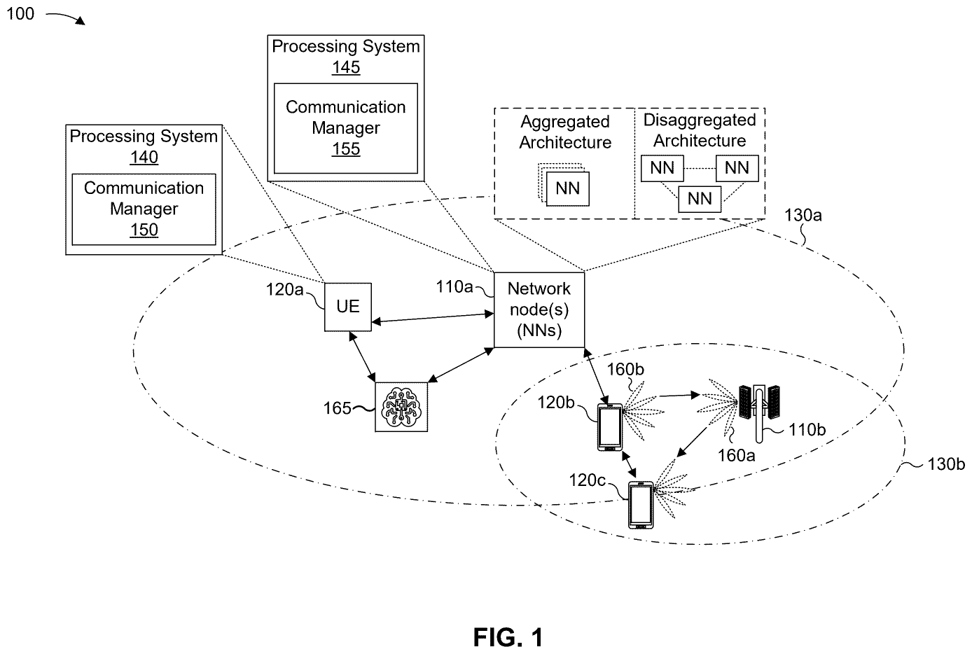

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

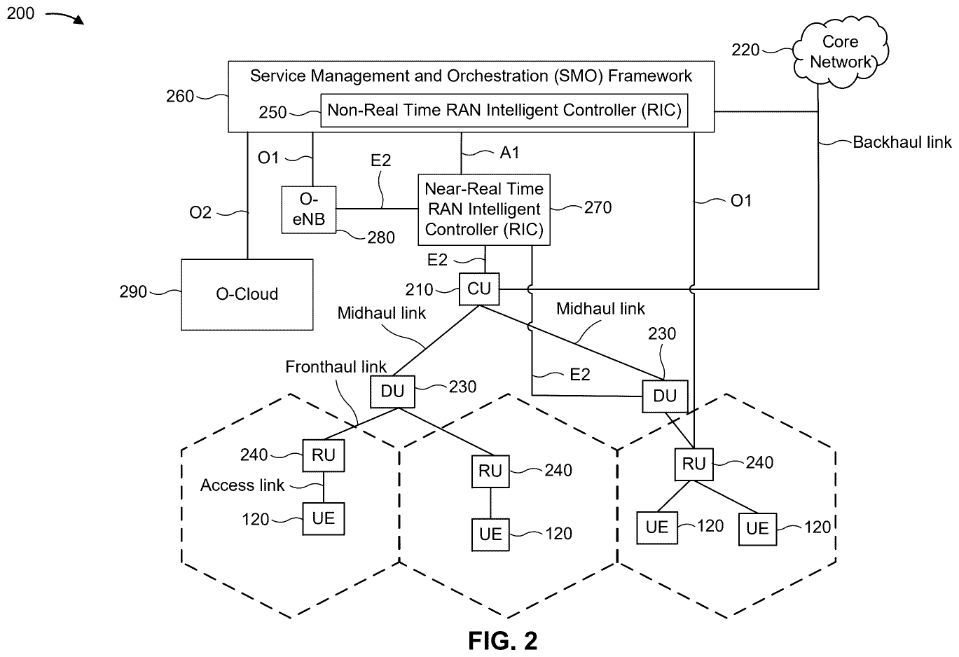

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ NACK indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive, from a network node, first control information that schedules an initial transmission of a transport block associated with a HARQ process; receive, from the network node, second control information that schedules a retransmission of the transport block based at least in part on the initial transmission of the transport block being associated with a HARQ NACK indication; and communicate, with the network node, the retransmission of the transport block in accordance with a continuous rate matching mode based at least in part on one or more conditions. Additionally, or alternatively, the communication manager 150 may perform one or more other operations described herein.

In some aspects, the network node 110 may include a communication manager 155. As described in more detail elsewhere herein, the communication manager 155 may transmit, to a UE, first control information that schedules an initial transmission of a transport block associated with a HARQ process; transmit, to the UE, second control information that schedules a retransmission of the transport block based at least in part on the initial transmission of the transport block being associated with a HARQ NACK indication; and communicate, with the UE, the retransmission of the transport block in accordance with a continuous rate matching mode based at least in part on one or more conditions. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

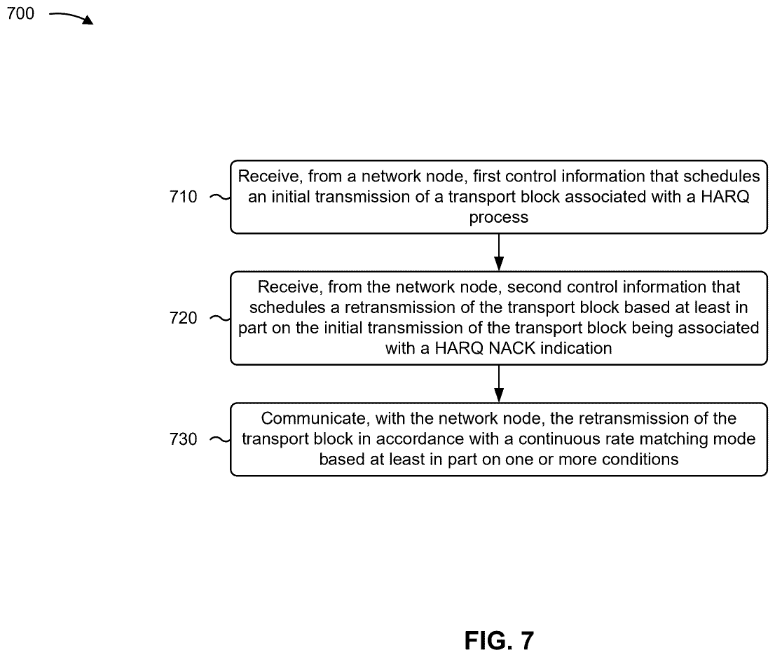

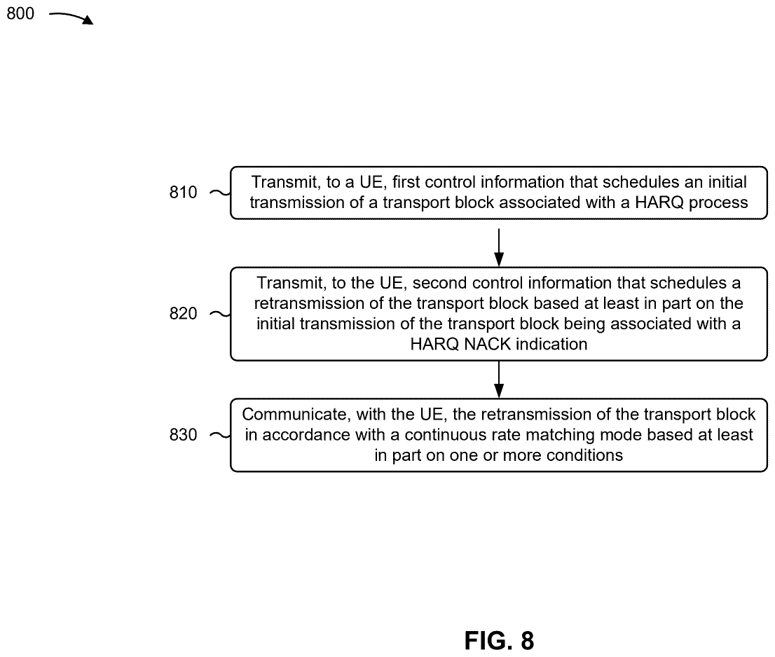

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with continuous rate matching for HARQ retransmission, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

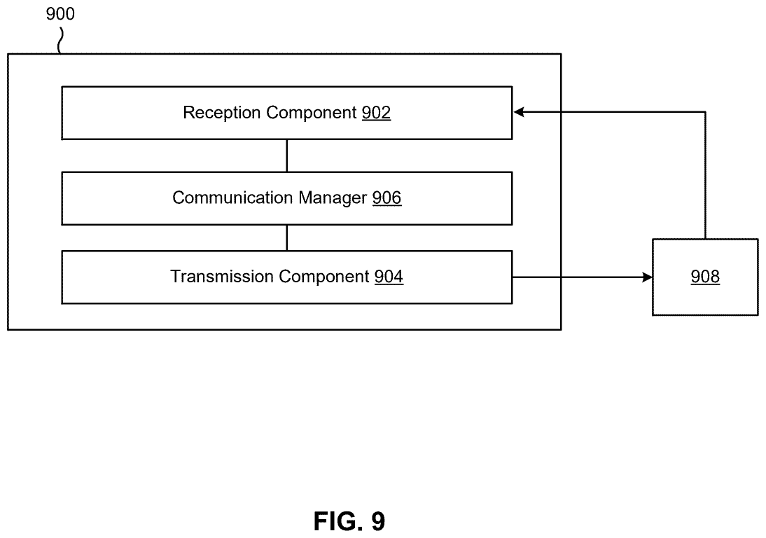

In some aspects, a UE includes means for receiving, from a network node, first control information that schedules an initial transmission of a transport block associated with a HARQ process; means for receiving, from the network node, second control information that schedules a retransmission of the transport block based at least in part on the initial transmission of the transport block being associated with a HARQ NACK indication; and/or means for communicating, with the network node, the retransmission of the transport block in accordance with a continuous rate matching mode based at least in part on one or more conditions. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

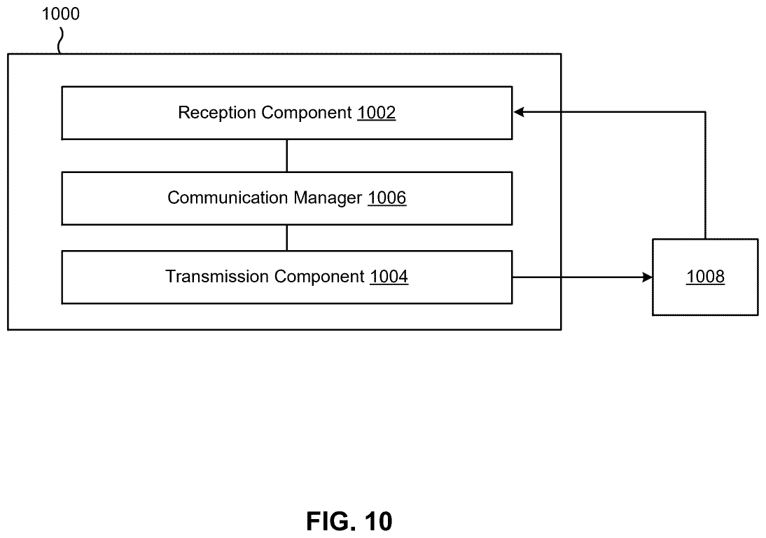

In some aspects, a network node includes means for transmitting, to a UE, first control information that schedules an initial transmission of a transport block associated with a HARQ process; means for transmitting, to the UE, second control information that schedules a retransmission of the transport block based at least in part on the initial transmission of the transport block being associated with a HARQ NACK indication; and/or means for communicating, with the UE, the retransmission of the transport block in accordance with a continuous rate matching mode based at least in part on one or more conditions. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

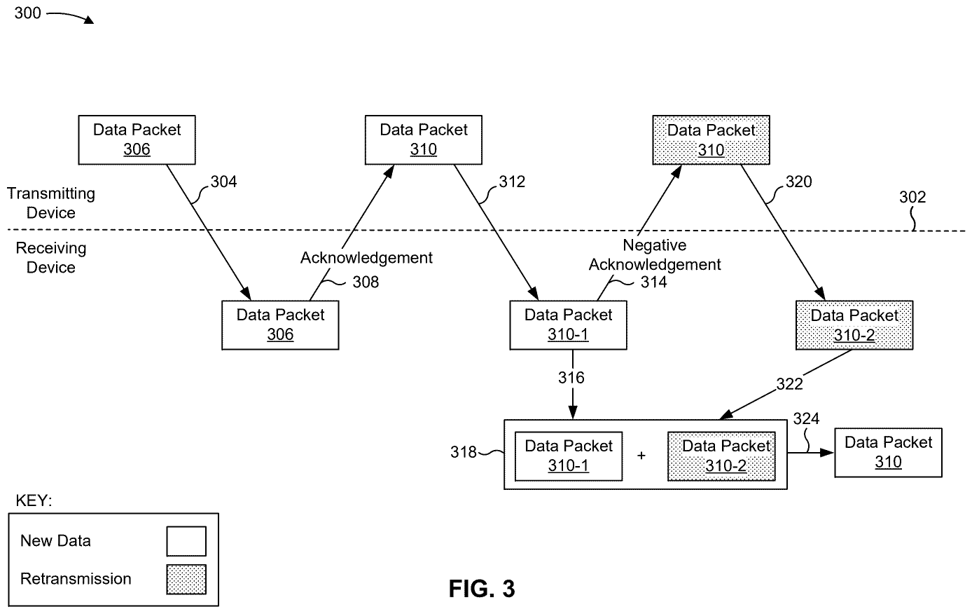

FIG. 3 is a diagram illustrating an example 300 of a HARQ process, in accordance with the present disclosure.

A MAC layer of a protocol stack may implement a HARQ protocol to provide a faster retransmission mechanism relative to other retransmission mechanisms, such as a radio link control (RLC) layer retransmission system. In some examples, the HARQ protocol may include a transmitting device using a retransmission protocol in combination with a receiving device, such as a send and wait (SAW) protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device-receiving device pairs that may implement a HARQ process in combination may include a network node 110 and a UE 120 (e.g., a downlink HARQ process), a UE 120 and a network node 110 (e.g., an uplink HARQ process), and/or a first UE 120 and a second UE 120 (e.g., a sidelink HARQ process). Thus, a HARQ process may be used for downlink communications, uplink communications, and/or sidelink communications. In some examples, and as part of a HARQ process, a network node may transmit information in downlink control information (DCI) that indicates to a receiving device (e.g., a UE 120) which downlink transmission(s) and/or which uplink transmissions to process using a HARQ protocol. Alternatively, or additionally, and as part of the HARQ process, a first UE may transmit information in sidelink control information (SCI) that indicates, to a second UE, which sidelink transmission(s) to process using the HARQ protocol.

In some examples, a HARQ process and/or HARQ protocol may enable a receiving device to correct errors in a received data packet, such as by correcting errors within a TB based at least in part on soft-combining packets in a physical (PHY) layer as described below. In some examples, a TB may be partitioned into one or more code block groups (CBGs), and each CBG may partitioned into one or more code blocks (CBs). To correct for errors, the receiving device may buffer one or more data packets that have been identified as including an error, combine the data packets, and process the combined data packets to reduce errors. In some examples, “codeword (CW)” may refer to a TB that includes error protection, and a transmission may include multiple CWs.

In the context of feedback information (e.g., HARQ feedback), “codebook” refers to a set of one or more (e.g., a matrix of one or more) feedback indications (e.g., ACK or NACK indications) that can be transmitted via a single transmission (e.g., a single uplink transmission). A HARQ feedback codebook transmission may include a feedback message to provide feedback regarding, for example, downlink data transmission (e.g., transmissions associated with a downlink channel), uplink data transmission (e.g., transmissions associated with an uplink channel), or sidelink data transmission (e.g., transmissions associated with a sidelink channel). As used herein, a codebook may be a sequence of bits, which may be constructed using ACK/NACK feedback associated with multiple communications (e.g., multiple downlink communications) that are received during a feedback window. A codebook may include one or more codewords. A codeword may include a message or communication. For example, a codeword may include one or more ACK/NACK feedback indications (e.g., a sequence of one or more HARQ-ACK bit values and/or HARQ NACK bit values).

The example 300 includes transactions between a transmitting device and a receiving device. Operations and/or data located above dashed line 302 are performed by, and/or reside at, a transmitting device (e.g., a network node 110 for a downlink HARQ process, a UE 120 for an uplink HARQ process, and/or a first UE 120 for a sidelink HARQ process). Operations and/or data located below the dashed line 302 are performed by, and/or reside at, a receiving device (e.g., a UE 120 for a downlink HARQ process, a network node 110 for an uplink HARQ process, and/or a second UE 120 for a sidelink HARQ process). As shown by reference number 304, the transmitting device may transmit a first data packet 306 that is a new transmission of data that is included in the first data packet 306 (e.g., a first transmission of the data, shown through the use of solid white). In some examples, the transmitting device may buffer and/or store the first data packet 306 as part of a HARQ process until receiving an indication from the receiving device that the first data packet 306 has been received and/or recovered with minimal errors (e.g., error-free and/or a number of errors that satisfy a low threshold). Based at least in part on receiving the first data packet 306 with minimal errors, the receiving device may transmit an ACK to the transmitting device as shown by reference number 308, such as a HARQ acknowledgement. The receiving device may validate the first data packet 306 using any suitable error detection mechanism, such as a cyclic redundancy check (CRC) process that validates the received data by computing a CRC value using the received data and comparing the computed CRC value(s) to a CRC value included with the received data.

Based at least in part receiving the ACK, the transmitting device may transmit a second data packet 310 as shown by reference number 312, and the second data packet 310 may be a new transmission of data (e.g., different data than the data included in the first data packet 306). In a similar manner as the first data packet 306, the transmitting device may store the second data packet 310 in the buffer and/or remove the first data packet 306 from the buffer. In some examples, the receiving device may not receive the second data packet 310 successfully, shown in FIG. 3 as data packet 310-1. For example, the receiving device may identify that the data packet 310-1 was received with a number of errors that do not satisfy the low error threshold. Accordingly, and as shown by reference number 314, the receiving device may transmit a NACK to indicate that the second data packet 310 was received with errors and/or unsuccessfully. Alternatively, or additionally, the receiving device may transmit the NACK to indicate a request for a retransmission of the second data packet 310. In some examples, and as shown by reference number 316, the receiving device may store the data packet 310-1 in a buffer 318.

Based at least in part on receiving the NACK, and as shown by reference number 320, the transmitting device may retransmit the second data packet 310 to the receiving device, where the retransmission is shown by FIG. 3 through the use of a dotted pattern. The receiving device may receive the retransmission of the second data packet 310 (shown as data packet 310-2), and, as shown by reference number 322, the receiving device may store the data packet 310-2 in the buffer 318 and/or may combine the data packet 310-1 with the data packet 310-2. As one example, the receiving device may combine the data packet 310-1 and the data packet 310-2 prior to channel decoding and/or error detection, and may process the combined data packet to mitigate errors as shown by reference number 324. That is, by processing the combined data packet, the receiving device may recover data that includes minimal errors (e.g., is error-free and/or includes a number of errors that satisfy the low error threshold). In some examples, the receiving may combine the data packet 310-1 and the data packet 310-2 using soft-combining. “Soft combining” may denote combining multiple received signals based at least in part on a confidence and/or reliability of each received signal, such as by combining received signals using a log likelihood ratio (LLR), to improve a signal quality of the combined data packet and reduce recovery errors.

In some examples, the receiving device may transmit an ACK to the transmitting device, such as in scenarios that the receiving device is able to recover a version of the second data packet 310 that includes minimal errors. In other examples, the receiving device may transmit a NACK to the transmitting device, such as in scenarios that the receiving device is unable to recover a version of the second data packet 310 with minimal errors.

A HARQ process may be used to regulate any combination of PDSCH transmissions, PUSCH transmissions, and/or physical sidelink shared channel (PSSCH) transmissions. Accordingly, the first data packet 306 and/or the second data packet 310 shown by FIG. 3 may be based at least in part on one or more PDSCH transmissions, one or more PUSCH transmissions, and/or one or more PSSCH transmissions. For PDSCH transmissions, the receiving device (e.g., a UE 120) may transmit ACK/NACK feedback via PUCCH or PUSCH. For PUSCH transmission, the receiving device (e.g., a network node 110) may transmit ACK/NACK feedback in an uplink grant (e.g., indicated via downlink control information (DCI)). For a sidelink transmission, the receiving device (e.g., a UE 120) may transmit ACK/ACK feedback via a physical sidelink feedback channel (PSFCH).

As indicated above, FIG. 3 is provided as an example. Other examples may differ from what is described with regard to FIG. 3.

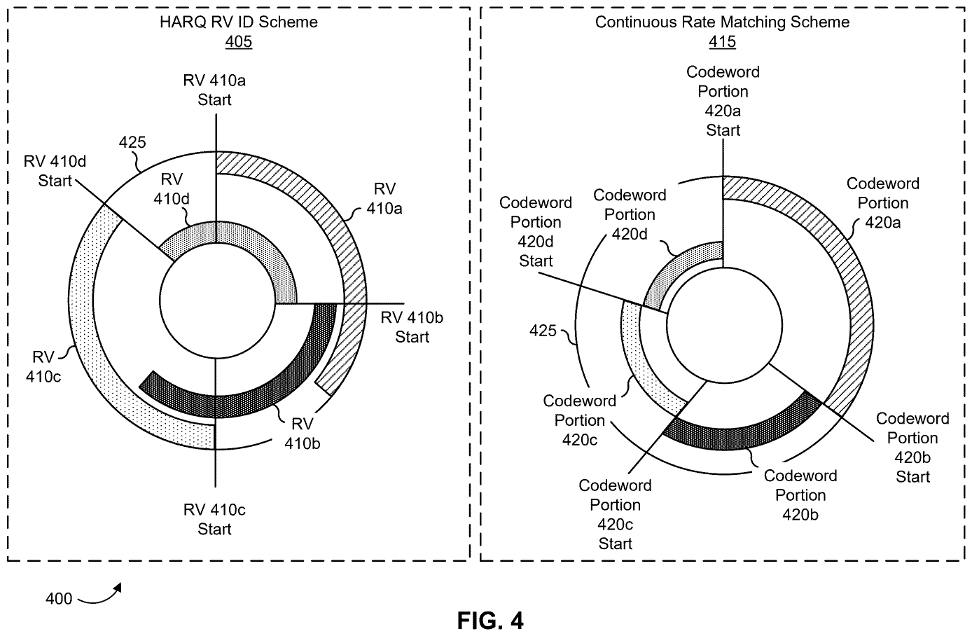

FIG. 4 is a diagram illustrating an example 400 of HARQ redundancy techniques, in accordance with the present disclosure. Example 400 may implement or be implemented by one or more aspects of FIGS. 1 through 3. For instance, example 400 may implement one or more aspects of the HARQ process, as described with reference to FIG. 3. Additionally, the techniques of example 400 may be implemented at a transmitting device and/or a receiving device. In example 400, the receiving device may be described as the UE 120, and the transmitting device may be described as the network node 110; however, the transmitting device and receiving device may be of any of the wireless device types described elsewhere herein.

As shown in FIG. 4, the UE 120 and the network node 110 may be associated with and/or include a circular buffer 425. For example, the UE 120 may use the circular buffer 425 to store transmissions and/or retransmissions of a data packet (such as a TB) in accordance with the HARQ process. Additionally, the network node 110 may encode a TB into a codeword to enable robustness against channel impairments. As described elsewhere herein, a codeword may be the encoded representation of the TB that may include both the original data bits of the TB and redundancy bits added for error detection and correction. For instance, the network node 110 may generate the redundancy bits during the channel coding process and enable the UE 120 to detect and correct errors in the transmitted data. In some examples, one full rotation around the circular buffer 425 may represent storing the entire codeword associated with the TB.

In some examples, the UE 120 may store information associated with a TB in accordance with a HARQ RV ID scheme 405. For instance, to improve the efficiency of HARQ retransmissions, the network node 110 and the UE 120 may operate in accordance with incremental redundancy controlled by RV IDs. In some examples, the RV ID may specify which portion of the codeword may be transmitted in a particular HARQ transmission or retransmission. As shown in FIG. 4, the codeword stored to the circular buffer 425 may be associated with four RVs 410 (e.g., RV 410a, 410b, 410c, and 410d). In some examples, each RV 410 may be an example of or associated with a different RV ID (e.g., RV 410a may be associated with RV0, RV 410b may be associated with RV1, RV 410c may be associated with RV2, and RV 410d may be associated with RV3). In some examples, control information that schedules a HARQ transmission/retransmission associated with a TB may indicate the RV ID. For example, a first DCI that schedules an initial HARQ transmission of the TB may indicate RV0, and a second DCI that schedules a first HARQ retransmission of the TB may indicate RV2.

Additionally, the encoding process associated with the HARQ RV ID scheme 405 may indicate how the UE 120 may store different portions of the codeword associated with different RV IDs to the circular buffer 425. For instance, as shown in FIG. 4, each RV ID may be associated with a different starting point in the circular buffer 425. Therefore, the UE 120 may use the RV ID associated with each HARQ transmission or retransmission of the TB to determine where to begin storing the received portion of the codeword. In some examples, network node 110 may transmit, and the UE 120 may receive, control signaling that indicates the starting point associated with each RV ID. For instance, such control signaling may include one or more of system information signaling (e.g., including MIB and/or SIB transmissions), RRC signaling, MAC signaling (e.g., one or more MAC-CEs), or DCI signaling. In some examples, the starting point associated with each RV ID may be preconfigured at the UE 120 (e.g., as part of an original equipment manufacturer (OEM) configuration) and/or associated with a wireless communications standard (e.g., 3GPP).

Additionally, each RV ID may be associated with varying combinations of data bits and redundancy bits of the codeword, which may enable subsequent retransmissions to provide complementary information to the UE 120. For instance, in one example, with reference to FIG. 3, the data packet 310-1 may be associated with RV0, such that the information included in the data packet 310-1 may include a first portion of a codeword associated with RV 410a. Therefore, the UE 120 may begin storing the first portion of the codeword to the circular buffer 425 at the starting point associated with RV 410a. In some examples, the initial HARQ transmission (RV0) may contain a portion of the codeword with more data bits and fewer redundancy bits. Therefore, HARQ retransmissions (e.g., associated with RV1, RV2, and RV3) may be enabled to include different combinations of redundancy bits and data bits. For instance, in the example with reference to FIG. 3, the data packet 310-2 may be associated with RV2, such that the information included in the data packet 310-2 may include a second portion of the codeword associated with RV 410c. Therefore, the UE 120 may begin storing the second portion of the codeword to the circular buffer 425 at the starting point associated with RV 410c. As shown in FIG. 4, RV 410c may not overlap with RV 410a, such that RV 410c may include the second portion of the codeword that is different from the first portion of the codeword associated with RV 410a. In some examples, the RV 410c may include fewer data bits and more redundancy bits compared to the RV 410a, such that RV 410c may provide the UE 120 with an increased number of redundancy bits to increase the probability of decoding the TB.

In some examples, one or more RV IDs may be associated with portions of the codeword that overlap with other portions of the codeword associated with other RV IDs. For instance, as shown in FIG. 4, the RV 410b (e.g., RV1) may be associated with a third portion of the codeword that at least partially overlaps with the first portion of the codeword associated with RV 410a and the second portion of the code word associated with RV 410c. Additionally, the RV 410d (e.g., RV3) may be associated with a fourth portion of the codeword that at least partially overlaps with the first portion of the codeword associated with RV 410a. By receiving different portions of the codeword that at least partially overlap, the HARQ RV ID scheme 405 may enable further redundancy, such that if the initial HARQ transmission of RV0 is received at the UE 120 with one or more errors (such as bit errors), the UE 120 may use the HARQ retransmissions of RV1 and/or RV3 to identify the one or more errors.

In some examples, at the UE 120, the received portions of the codeword from the HARQ transmission and one or more HARQ retransmissions may be soft-combined. As described elsewhere herein, soft-combining is a process where the UE 120 aggregates the reliability metrics (e.g., likelihood or confidence levels) for each received bit from multiple transmissions. By combining these bits, the UE 120 may generate a more complete and robust representation of the original codeword, which may enable the UE 120 to decode the TB successfully.

Therefore, the flexibility provided by the HARQ RV ID scheme 405 may increase the likelihood of successful decoding with fewer retransmissions. Additionally, by systematically providing different portions of the codeword, the HARQ RV ID scheme 405 may reduce redundant retransmissions, which may increase the efficiency of wireless resources.

In some examples, to perform soft-combining and/or other aspects of the HARQ process, the UE 120 may determine a TB size (TBS). For example, the TBS may be a number of original data bits included in the TB. In some examples, the UE 120 may determine the TBS for a TB based on resource allocation information and a code rate indicated in a DCI that schedules the initial HARQ transmission for the TB. For example, the resource allocation information indicated by the DCI may indicate a frequency domain resource allocation (FDRA) (e.g., that specifies the frequency domain resources, such as subcarrier or resource blocks, assigned to the UE 120 for the initial HARQ transmission), indicate a time domain resource allocation (TDRA) (e.g., that specifies the time domain resources, such as slots or symbols, assigned to the UE 120 for the initial HARQ transmission), and/or indicate a number of layers (e.g., that specifies the number of spatial layers/streams used for the initial HARQ transmission). In some examples, determination of the TBS may exclude the DMRS resource elements associated with the initial HARQ transmission. Additionally, the DCI may include an MCS field that indicates the code rate. For example, the MCS field may be a set of bits that points to an index of an MCS index table (e.g., configured at the UE 120 and/or associated with a wireless communications standard, such as 3GPP). A given index may indicate a modulation order and the code rate which indicates the MCS for the initial HARQ transmission. The modulation order may refer to a number of distinct symbols that can be transmitted per unit time for an associated wireless transmission, which corresponds to the number of bits represented by each symbol (e.g., orders of 2, 4, and 6 may be respectively associated with modulation schemes such as binary phase shift keying (BPSK), quadrature phase shift keying (QPSK), and 64-QAM). The code rate may indicate the ratio of data information bits over the total number of data information bits and redundancy bits in the transmission. For example, a HARQ transmission with a code rate of 0.50 may include 50% data information bits and 50% redundancy bits. Therefore, the UE 120 may use the resource allocation information and the code rate indicated by the DCI to determine the TBS for a TB.

In some examples of HARQ retransmissions, the network node 110 may indicate, in the scheduling DCI, a reserved MCS. The reserved MCS may indicate the modulation order for the HARQ retransmission and may not indicate the code rate. Therefore, the network node 110 may indicate a reserved MCS for HARQ retransmissions, where the UE 120 has previously determined the TBS of the TB from the initial HARQ transmission. Accordingly, the UE 120 may use the previously determined TBS to correctly store the bits of the HARQ retransmission to the circular buffer 425 (for example, and use the LLRs associated with the bits stored to the circular buffer 425 for subsequent soft-combining). In some examples, the network node 110 may indicate a reserved MCS for HARQ retransmissions to increase flexibility of resource allocation for the retransmissions. For example, because the UE 120 has already determined the TBS, the network node 110 may use a different TDRA, a different FDRA, a different MCS, and/or a different number of layers for the HARQ retransmission, compared to the initial HARQ transmission. Such changes in the resource allocation information and/or the MCS may enable the network node 110 to adapt HARQ retransmissions of a TB to increase probability of successful decoding of the TB at the UE 120.

In some examples, increasing the number of RV IDs associated with the HARQ RV ID scheme 405 may increase the coding gain associated with the incremental redundancy for HARQ. For example, increasing the number of RV IDs may increase coding diversity. For example, each RV ID may correspond to a specific portion of the codeword from the encoding process, which may be stored in the circular buffer 425. Therefore, by increasing the number of RV IDs, more unique subsets of the codeword may be transmitted over multiple HARQ transmissions, which may provide the UE 120 with additional, complementary information, enhancing the diversity of redundancy available for decoding. Additionally, or alternatively, increasing the number of RV IDs may improve error correction capabilities. For example, when the number of RV IDs is higher, the UE 120 may gain access to a broader set of encoded bits, which improves the likelihood of reconstructing the original data of the codeword correctly. Additionally, or alternatively, increasing the number of RV IDs may enhance incremental redundancy. For example, increasing the RV IDs enables a more gradual accumulation of redundancy, allowing the HARQ process to better adapt to challenging channel conditions, such as channel conditions associated with a signal-to-noise ratio (SNR) below an SNR threshold. Additionally, or alternatively, increasing the number of RV IDs may increase coding gain. For example, “coding gain” may refer to an improvement in error correction capability due to the additional redundancy and diversity provided by the coding process. Therefore, by using more RV IDs, the effective redundancy may be spread across multiple transmissions, improving the overall reliability of decoding.

In some cases, however, increasing the number of configured RV IDs may increase signal overhead for scheduling HARQ transmissions and retransmissions. For example, the scheduling DCI may indicate the RV ID for a HARQ transmission/retransmission via an RV ID field, where four RV IDs may be indicated if the bit-width of the RV ID field is two (e.g., ‘00’ indicates RV0, ‘01’ indicates RV1, ‘10’ indicates RV2, and ‘11’ indicates RV3). However, increasing the number of RV IDs above four may increase the bit-width of the RV ID field, which may increase signaling overhead.

In some examples, the UE 120 and network node 110 may operate in accordance with a continuous rate matching scheme 415 to achieve the benefits of increasing the number of configured RV IDs. In accordance with the continuous rate matching scheme 415, a portion of the codeword indicated in a first HARQ retransmission may be directly after a portion of the codeword indicated in the initial HARQ transmission of a TB. For instance, as shown in FIG. 4, an initial HARQ transmission may indicate a codeword portion 420a which the UE 120 may store to the circular buffer 425 starting at the beginning of the circular buffer 425. If the initial HARQ transmission results in a NACK, then the network node 110 may transmit a first HARQ retransmission that may indicate a codeword portion 420b which the UE 120 may store to the circular buffer 425 directly after the codeword portion 420a. In some examples, as shown in FIG. 4, if the UE 120 is unable to decode the TB after storing codeword portions 420a and 420b, then the network node 110 may further transmit a second HARQ retransmission that may indicate a codeword portion 420c, which the UE 120 may store to the circular buffer 425 directly after the codeword portion 420b. In some examples, as shown in FIG. 4, if the UE 120 is unable to decode the TB after storing codeword portions 420a through 420c, then the network node 110 may further transmit a third HARQ retransmission that may indicate a codeword portion 420d, which the UE 120 may store to the circular buffer 425 directly after the codeword portion 420c. Therefore, the continuous rate matching scheme 415 may enable the UE 120 to receive portions of the codeword in order rather than receiving RV IDs to indicate where in the circular buffer 425 to store a codeword portion 420. In some examples, the continuous rate matching scheme 415 may partition the codeword into any number of codeword portions 420, where each codeword portion 420 may include a respective number of bits included in the original codeword. In some examples of the continuous rate matching scheme 415, a given codeword portion 420 may loop back around the circular buffer 425 such that at least a part of the given codeword portion 420 includes bits from one or more previous HARQ transmissions/transmissions.

In some cases, however, one or more aspects of continuous rate matching may be dependent on the UE 120 successfully receiving each of the one or more DCIs that respectively schedule the one or more HARQ transmissions/retransmissions. For example, if the UE 120 does not receive the DCI scheduling the initial HARQ transmission, then the UE 120 may be unaware of where to start storing the codeword portion 420a to the circular buffer 425 and at which point in the circular buffer 425 the codeword portion 420a ends. Therefore, the UE 120 may be unaware of where to start storing the codeword portion 420b into the circular buffer 425. In some examples, the network node 110 may indicate additional information associated with each codeword portion 420 (e.g., codeword length, start point, and/or end point, among other examples). However, such additional information may increase the overhead signaling for the DCIs above the signaling overhead associated with the HARQ RV ID scheme 405 that includes four RV IDs.

However, as described herein, if the network node 110 indicates in the DCI scheduling the first HARQ retransmission a reserved MCS, then the network node 110 may be aware that the UE 120 successfully received the DCI scheduling the initial HARQ transmission. Therefore, in such cases where reserved MCS is used, the network node 110 and UE 120 may operate in accordance with continuous rate matching scheme 415 to increase coding gain associated with the HARQ process. Accordingly, techniques provided elsewhere herein may describe one or more conditions in which the UE 120 and network node 110 operate in accordance with the continuous rate matching scheme 415 and when the UE 120 and network node 110 may fall back to the HARQ RV ID scheme 405.

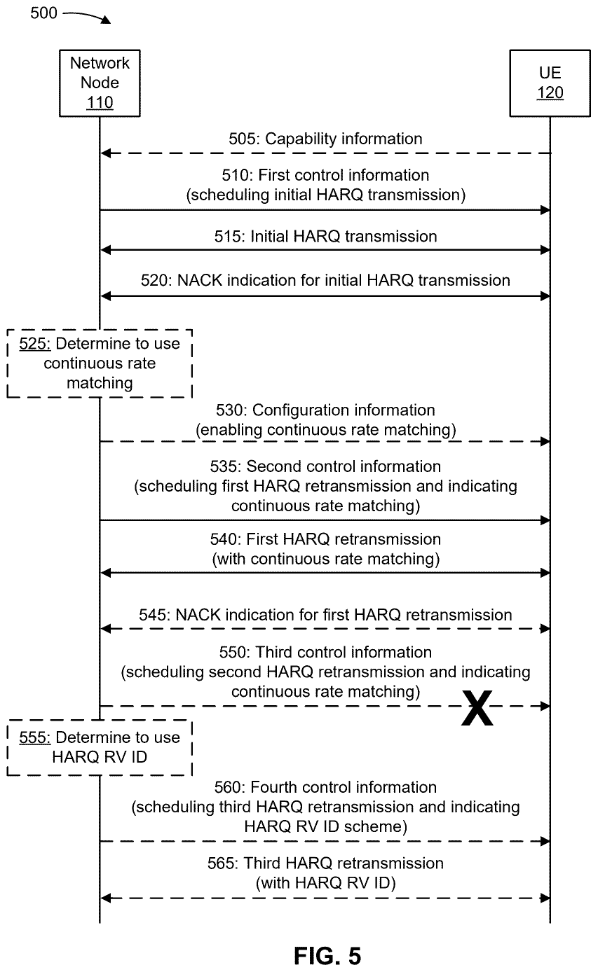

FIG. 5 is a diagram illustrating an example 500 associated with continuous rate matching for HARQ retransmission, in accordance with the present disclosure. Example 500 may implement or be implemented by one or more aspects of FIGS. 1 through 4. For instance, example 500 includes wireless communications between the network node 110 and the UE 120 that operate in accordance with one or more of HARQ RV ID scheme 405 and continuous rate matching scheme 415. Alternative examples of the following may be implemented, where some operations are performed in a different order than described, or not described at all. In some cases, one or more operations may include additional features not mentioned below, or further operations may be added. In addition, while example 500 shows operations between the UE 120 and the network node 110, the communication may occur between any number of network devices of various types described herein.

In some aspects, as shown by a first operation 505, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the UE 120. The one or more parameters may be indicated via respective information elements (IEs) included in a capability report.

The capability information may indicate whether the UE 120 supports a feature and/or one or more parameters related to the feature. For example, the capability information may indicate a capability and/or parameter for supporting operation in accordance with a continuous rate matching mode. In other words, the capability information may indicate that the UE 120 can store codeword portions to a circular buffer at the UE 120 in accordance with the continuous rate matching scheme 415, as described with reference to FIG. 4. One or more operations described herein may be based on the capability information. For example, the UE 120 may perform one or more operations of example 500 in accordance with the capability information or may receive configuration information that is in accordance with the capability information.

In a second operation 510, the network node 110 may transmit, and the UE 120 may receive, first control information. For example, the first control information may be a first DCI that schedules an initial HARQ transmission of a TB associated with a HARQ process. In some examples, the TB may be an uplink TB such that the first DCI schedules the UE 120 to transmit an initial uplink HARQ transmission. In some examples, the TB may be a downlink TB such that the first DCI schedules the UE 120 to receive an initial downlink HARQ transmission.

In a third operation 515, the UE 120 and the network node 110 may communicate the initial HARQ transmission in accordance with the first control information. For example, if the network node 110 schedules an uplink TB, then the UE 120 may transmit, and the network node 110 may receive, the initial uplink HARQ transmission. Alternatively, if the network node 110 schedules a downlink TB, then the network node 110 may transmit, and the UE 120 may receive, the initial downlink HARQ transmission.

In a fourth operation 520, the UE 120 and the network node 110 may communicate a HARQ NACK indication. For example, the UE 120 or the network node 110 may be able to receive the initial HARQ transmission, but unable to decode the TB associated with the initial HARQ transmission. Therefore, the HARQ NACK indication may indicate unsuccessful decoding of the initial HARQ transmission. If the UE 120 transmits the initial uplink HARQ transmission, then the network node 110 may transmit, and the UE 120 may receive, the HARQ NACK indication associated with the initial uplink HARQ transmission. If the network node 110 transmits the initial downlink HARQ transmission, then the UE 120 may transmit, and the network node 110 may receive, the HARQ NACK indication associated with the initial downlink HARQ transmission.

In a fifth operation 525, the network node 110 may optionally determine to use continuous rate matching for a first HARQ retransmission for the TB. In some examples, the use of continuous rate matching may be based on one or more conditions. In some examples, the one or more conditions include the capability information indicating support of the UE 120 to operate in accordance with the continuous rate matching mode.

Additionally, or alternatively, the one or more conditions may include satisfying a confidence level that the UE 120 successfully received the first control information. In cases where the UE 120 transmits the initial uplink HARQ transmission, the network node 110 may determine the confidence level based on whether the network node 110 successfully and/or correctly detects an associated uplink DMRS. For instance, if the network node 110 correctly detects the uplink DMRS included as part of the initial uplink HARQ transmission, then the network node 110 may determine to indicate continuous rate matching for the first HARQ retransmission of the TB. In cases where the network node 110 transmits the initial downlink HARQ transmission, the network node 110 may determine the confidence level based on detection of the HARQ NACK indication from the UE 120 associated with the initial downlink HARQ transmission. For instance, if the network node 110 receives the HARQ NACK indication with a signal quality metric that satisfies a signal quality threshold, then the network node 110 may determine to indicate continuous rate matching for the first HARQ retransmission of the TB. In some examples, the signal quality metric may be one or more of reference signal received power (RSRP), reference signal received quality (RSRQ), signal-to-noise ratio (SNR), signal-to-interference-plus-noise ratio (SINR), channel quality indicator (CQI), block error rate (BLER), bit error rate (BER), error vector magnitude (EVM), and received signal strength indicator (RSSI).

Additionally, or alternatively, the one or more conditions may include the network node 110 determining to indicate reserved MCS for the first HARQ retransmission of the TB. For example, the network node 110 may indicate reserved MCS of HARQ retransmissions in cases where the network node 110 is aware that the UE 120 successfully received the first control information. The network node 110 may be aware that the UE 120 successfully received the first control information based on receiving the initial uplink HARQ transmission or receiving a HARQ NACK indication associated with the initial downlink HARQ transmission.

The network node 110 may determine configuration information for the UE 120 based on the capability information. For example, the network node 110 may determine that the UE 120 is to be enabled to operate in accordance with the continuous rate matching mode for HARQ retransmissions based on the capability information indicating support for operating in the continuous rate matching mode (e.g., operating in accordance with the continuous rate matching scheme 415).

In a sixth operation 530, the network node 110 may optionally transmit, and the UE 120 may receive, the configuration information. In some aspects, the UE 120 may receive the configuration information via one or more of system information signaling (e.g., a MIB and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In a seventh operation 535, the network node 110 may transmit, and the UE 120 may receive, second control information. For example, the second control information may be a second DCI that schedules the first HARQ retransmission in accordance with continuous rate matching.

In some examples, the UE 120 may be aware that the first HARQ retransmission is in accordance with continuous rate matching based on receiving the configuration information that enables a continuous rate matching mode at the UE 120. Therefore, the configuration information may enable the network node 110 to refrain from indicating whether continuous rate matching is enabled in each DCI scheduling HARQ retransmissions, which may reduce the signaling overhead of the DCIs. In some examples, the network node 110 may transmit, and the UE 120 may receive, a second configuration information that may deactivate the continuous rate matching mode at the UE 120, if the network node 110 determines to fall back to using the HARQ RV ID scheme.

In some examples, the UE 120 may be aware that the first HARQ retransmission is in accordance with continuous rate matching based on the second control information indicating reserved MCS for the first HARQ retransmission. In other words, the UE 120 may determine to operate in the continuous rate matching mode for the first HARQ retransmission based on the indication of reserved MCS. From the perspective of the UE 120, the continuous rate matching may include starting the circular buffer from the end of the previous received/transmitted coded bits of the previous transmission/retransmissions of the associated TB (e.g., in accordance with the continuous rate matching scheme 415). In examples where the second control information indicates a reserved MCS, then the network node 110 may assume that the UE 120 uses the continuous rate matching from the previous HARQ transmission/retransmission. Additionally, the network node 110 may assume that the UE 120 received the previous scheduling grant (e.g., the first control information) such that the UE 120 knows where to start storing the received coded bits of the first HARQ retransmission to the circular buffer.

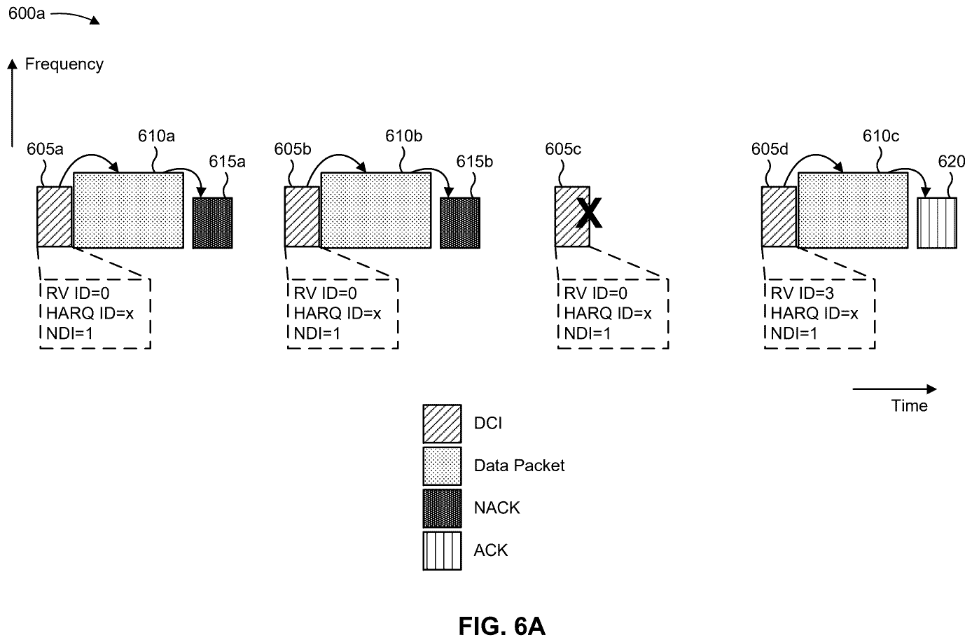

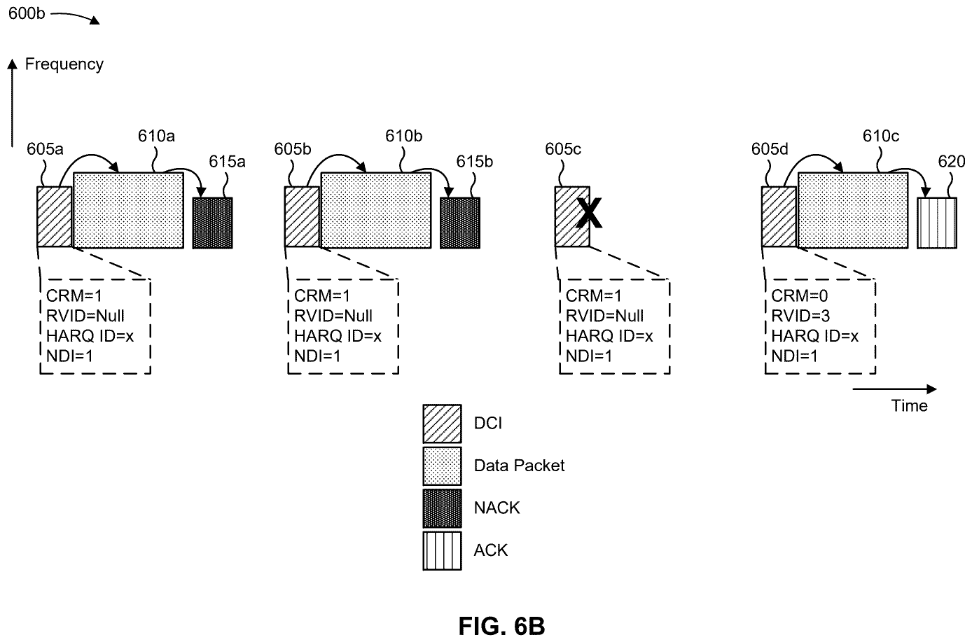

In some examples, in addition to the second control information indicating reserved MCS, the UE 120 may determine to use continuous rate matching for the first HARQ retransmission based on a value of an RV ID field included in the second control information. In a first implementation, the RV ID field of the second control information may include a first RV ID (e.g., a special RV ID) that indicates continuous rate matching. For instance, in the first implementation, if second control information indicates reserved MCS and indicates that the RV ID field is set to the special RV ID (e.g., RV ID field=0), then the UE 120 may communicate the first HARQ retransmission in accordance with continuous rate matching (e.g., in accordance with the continuous rate matching scheme 415). Alternatively, in the first implementation, if second control information indicates reserved MCS and indicates that the RV ID field is set to an RV ID different than special RV ID (e.g., RV ID field≠0), then the UE 120 may communicate the first HARQ retransmission in accordance with the RV ID indicated (e.g., in accordance with HARQ RV ID scheme 405). Further discussion of the first implementation is provided elsewhere herein (e.g., including FIG. 6A).

In a second implementation, an additional bit may be added to the RV ID bit field of the second control information, where the additional bit may indicate whether continuous rate matching is enabled. That is, in the second implementation, the RV ID field may include the additional bit and a set of bits, where the set of bits are associated with indicating the RV ID. If the additional bit is set to a first value (e.g., additional bit=1), then the UE 120 may communicate the first HARQ retransmission in accordance with continuous rate matching (e.g., in accordance with the continuous rate matching scheme 415) and ignore the set of bits associated with indicating the RV ID. Alternatively, if the additional bit is set to a second value (e.g., additional bit=0), then the UE 120 may communicate the first HARQ retransmission in accordance with an RV ID indicated by the set of bits (e.g., in accordance with HARQ RV ID scheme 405). Further discussion of the second implementation is provided elsewhere herein (e.g., including FIG. 6B).

In an eighth operation 540, the network node 110 and the UE 120 may communicate the first HARQ retransmission using continuous rate matching in accordance with the second control information.

If the TB is an uplink TB, then the UE 120 may encode the first uplink HARQ retransmission in accordance with a second portion of a codeword stored in a circular buffer of the UE 120, where the second portion of the codeword is directly subsequent to a first portion of the codeword stored in the circular buffer, and the first portion of the codeword is associated with encoding the initial uplink HARQ transmission of the TB. The UE 120 may transmit, and the network node 110 may receive, the first uplink HARQ retransmission based on the UE 120 encoding the first uplink HARQ retransmission. Therefore, the network node 110 may store the second portion of the codeword to a circular buffer at the network node 110 directly subsequent to the first portion of the codeword stored at the circular buffer of the network node 110.

If the TB is a downlink TB, then the network may encode the first uplink HARQ retransmission in accordance with a second portion of a codeword stored in a circular buffer of the network, where the second portion of the codeword is directly subsequent to a first portion of the codeword stored in the circular buffer, and the first portion of the codeword is associated with encoding the initial downlink HARQ transmission of the TB. The network node 110 may transmit, and the UE 120 may receive, the first downlink HARQ retransmission based on the network encoding the first downlink HARQ retransmission. Therefore, the UE 120 may store the second portion of the codeword to a circular buffer at the UE 120 directly subsequent to the first portion of the codeword stored at the circular buffer of the UE 120.

In some examples, the UE 120 or the network node 110 may perform soft-combining (as described elsewhere herein) of the first portion and the second portion of the codeword. If, in accordance with the soft-combining, the UE 120 or the network node 110 is able to decode the TB, then the UE 120 and the network node 110 may communicate a HARQ ACK indication associated with the first HARQ retransmission. For instance, if the UE 120 successfully decodes the downlink TB after receiving the first downlink HARQ retransmission, then the UE 120 may transmit, and the network node 110 may receive, a HARQ ACK indication associated with the first downlink HARQ retransmission. Alternatively, if the network node 110 successfully decodes the uplink TB after receiving the first uplink HARQ retransmission, then the network node 110 may transmit, and the UE 120 may receive, a HARQ ACK indication associated with the first uplink HARQ retransmission.

If the UE 120 or the network node 110 is unable to decode the TB after soft-combining the first portion of the codeword and the second portion of the codeword, then in a ninth operation 545, the network node 110 and UE 120 may communicate a HARQ NACK indication for the first HARQ retransmission. If the UE 120 transmits the first uplink HARQ retransmission, then the network node 110 may transmit, and the UE 120 may receive, the HARQ NACK indication associated with the first uplink HARQ retransmission. If the network node 110 transmits the first downlink HARQ retransmission, then the UE 120 may transmit, and the network node 110 may receive, the HARQ NACK indication associated with the first downlink HARQ retransmission.

In a tenth operation 550, the network node 110 may optionally transmit third control information. For example, the third control information may be a third DCI scheduling a second HARQ retransmission of the TB. In some examples, the network node 110 may transmit the third control information if the NACK indication for the first HARQ retransmission is communicated in accordance with the ninth operation 545. In some examples, the third control information may indicate the use of continuous rate matching for the second HARQ retransmission (e.g., in similar ways as described with reference to the seventh operation 535). As illustrated in FIG. 5, the UE 120 may be unable to receive the third control information (e.g., based on operating in a low power mode and/or poor channel conditions associated with the third control information).

In an eleventh operation 555, the network node 110 may optionally determine to use a HARQ RV ID for a third HARQ retransmission of the TB (e.g., in accordance with the HARQ RV ID scheme 405). That is, the network node 110 may fall back from using continuous rate matching to using a HARQ RV ID. In some examples, using a HARQ RV ID may be referred to herein as a “traditional” or “legacy” HARQ process. In some examples, the network node 110 may determine to fall back to the HARQ RV ID scheme based on identifying that the UE 120 did not receive the third control information. That is, because the UE 120 did not receive the third control information, the UE 120 may be unable to continue performing continuous rate matching for the HARQ process of the TB. If the TB is a downlink TB, then the network node 110 may identify that the UE 120 did not receive the third control information based on not receiving a HARQ ACK/NACK indication associated with the second downlink HARQ retransmission before expiration of a first timer. If the TB is an uplink TB, then the network node 110 may identify that the UE 120 did not receive the third control information based on not receiving the second uplink HARQ retransmission before expiration of a second timer. Additionally, or alternatively, the network node 110 may determine to fall back to the HARQ RV ID scheme if a number of HARQ transmissions/retransmissions for the TB satisfies and/or exceeds a transmission number threshold.

In a twelfth operation 560, the network node 110 may optionally transmit, and the UE 120 may receive, fourth control information. For example, the fourth control information may be a fourth DCI that schedules a third HARQ retransmission of the TB in accordance with the HARQ RV ID scheme. That is, the HARQ RV ID field of the fourth control information may indicate an RV ID associated with communication of the third HARQ retransmission.

In a thirteenth operation 565, the network node 110 and the UE 120 may optionally communicate the third HARQ retransmission using the HARQ RV ID scheme in accordance with the fourth control information.

If the TB is an uplink TB, then the UE 120 may encode the third uplink HARQ retransmission in accordance with a portion of the codeword at the circular buffer of the UE 120 corresponding to the RV ID indicated in the fourth control information. The UE 120 may transmit, and the network node 110 may receive, the third uplink HARQ retransmission based on the UE 120 encoding the third uplink HARQ retransmission. Therefore, the network node 110 may store the coded bits of the third uplink HARQ retransmission at an indicated point in the circular buffer of the network node 110, where the indicated point is associated with the RV ID indicated in the fourth control information.

If the TB is a downlink TB, then the network node 110 may encode the third downlink HARQ retransmission in accordance with a portion of the codeword at the circular buffer of the network node 110 corresponding to the RV ID indicated in the fourth control information. The network node 110 may transmit, and the UE 120 may receive, the third downlink HARQ retransmission based on the network node 110 encoding the third downlink HARQ retransmission. Therefore, the UE 120 may store the coded bits of the third downlink HARQ retransmission at an indicated point in the circular buffer of the UE 120, where the indicated point is associated with the RV ID indicated in the fourth control information.

In some examples, the UE 120 or the network node 110 may perform soft-combining of the portions of the codeword received in the initial HARQ transmission, the first HARQ retransmission, and the third HARQ retransmission. If, in accordance with the soft-combining, the UE 120 or the network node 110 is able to decode the TB, then the UE 120 and the network node 110 may communicate a HARQ ACK indication associated with the first HARQ retransmission. For instance, if the UE 120 successfully decodes the downlink TB after receiving the third downlink HARQ retransmission, then the UE 120 may transmit, and the network node 110 may receive, a HARQ ACK indication associated with the third downlink HARQ retransmission. Alternatively, if the network node 110 successfully decodes the uplink TB after receiving the third uplink HARQ retransmission, then the network node 110 may transmit, and the UE 120 may receive, a HARQ ACK indication associated with the third uplink HARQ retransmission.

FIGS. 6A and 6B are diagrams illustrating examples 600a and 600b associated with indicating continuous rate matching for a HARQ process, in accordance with the present disclosure. Examples 600a and 600b may implement or be implemented by one or more aspects of FIGS. 1 through 5. For instance, example 600a provides an example of DCIs that include an RV ID field that indicates an RV ID, where a first RV ID may be a special RV ID that indicates continuous rate matching. Additionally, example 600b provides an example of DCIs that include an RV ID field that includes a first bit indicating whether continuous rate matching is enabled, and an additional set of bits indicating an RV ID if continuous rate matching is not enabled. Additionally, the techniques of examples 600a and 600b may be implemented at a transmitting device and/or a receiving device. In examples 600a and 600b, the receiving device may be described as the UE 120, and the transmitting device may be described as the network node 110; however, the transmitting device and receiving device may be any of the wireless device types described elsewhere herein.

In some examples, one or more messages of FIGS. 6A and 6B may be examples of or associated with one or more messages of FIG. 5. For example, a DCI 605a may be an example of the first control information in the second operation 510. The DCI 605a may schedule a data packet 610a, where the data packet 610a may be the initial HARQ transmission of the TB in the third operation 515. A NACK indication 615a may be an example of the HARQ NACK indication in the fourth operation 520. A DCI 605b may be an example of the second control information in the seventh operation 535. The DCI 605b may schedule a data packet 610b, where the data packet 610b may be the first HARQ retransmission in the TB of the eighth operation 540. A NACK indication 615b may be an example of the HARQ NACK indication in the ninth operation 545. A DCI 605c may be an example of the third control information in the tenth operation 550, where the UE 120 fails to receive the DCI 605c. A DCI 605d may be an example of the fourth control information in the twelfth operation 560. The DCI 605d may schedule a data packet 610c, where the data packet 610c may be the fourth HARQ retransmission of the TB in the thirteenth operation 565.

As shown in FIGS. 6A and 6B, each of DCIs 605a, 605b, 605c, and 605d may indicate a same NDI value (e.g., NDI=1). In some examples, the NDI value may be associated with managing HARQ processes and may distinguish between new data transmissions and retransmissions. For example, a toggled NDI may indicate new data, prompting the UE 120 to reset its HARQ buffer (e.g., the circular buffer 425). Alternatively, an unchanged NDI may indicate a retransmission, allowing the UE 120 to perform soft-combining for enhanced decoding reliability. Therefore, based on each of DCIs 605a through 605d indicating the same NDI value, the UE 120 may determine that each of DCIs 605a through 605d are associated with scheduling data packets 610 associated with the same TB. In some examples, the NDI value may be indicated via an NDI field of a given DCI 605.

As shown in FIGS. 6A and 6B, each of DCIs 605a, 605b, 605c, and 605d may indicate a same HARQ identifier (e.g., HARQ ID=x, where x may be an integer). For example, the HARQ identifier may enable the network node 110 and the UE 120 to uniquely identify the HARQ process associated with a specific transmission or retransmission. For instance, in an example where the UE 120 is handling eight HARQ processes concurrently, the HARQ identifier value in the DCI ensures that when a HARQ retransmission occurs for a particular HARQ process (e.g., process x), the UE 120 can retrieve the associated circular buffer for that HARQ process and perform soft-combining with the retransmitted data.

As shown in FIG. 6A, DCIs 605a, 605b, 605c, and 605d may indicate an RV ID. For example, the RV ID may be included in an RV ID field of the DCIs 605. In accordance with the techniques of FIG. 6A, a first value of the possible RV IDs indicated by RV ID field may indicate the use of continuous rate matching (e.g., the special RV ID). For example, as shown in FIG. 6A, if the RV ID=0, then the UE 120 determines that the associated HARQ transmission/retransmission is in accordance with continuous rate matching. The DCI 605a may indicate RV ID=0, and therefore the UE 120 may determine to store the coded bits of data packet 610a at the circular buffer in accordance with continuous rate matching. Additionally, the DCI 605a may indicate an explicit value for the MCS associated with data packet 610a (e.g., rather than a reserved MCS). The DCI 605b may indicate RV ID=0, and therefore the UE 120 may determine to store the coded bits of data packet 610b at the circular buffer, directly after the coded bits of data packet 610a, in accordance with continuous rate matching. Additionally, the DCI 605b may indicate reserved MCS associated with data packet 610b. The DCI 605c may indicate RV ID=0. However, as shown in FIG. 6A, the UE 120 may be unable to receive the DCI 605c. Based on the UE 120 not receiving the DCI 605c, the network node 110 may transmit the DCI 605d with a different RV ID to indicate fall back to the HARQ RV ID scheme. For example, the DCI 605d may indicate RV ID=3, and therefore the UE 120 may determine to store the coded bits of data packet 610c to the circular buffer at an indicated point of the circular buffer associated with RV ID=3. Additionally, the DCI 605d may indicate a reserved MCS associated with data packet 610c. In accordance with example 600A, the UE 120 may be able to perform soft-combining of the coded bits of data packets 610a, 610b, and 610c and successfully decode the associated TB. Therefore, the UE 120 may transmit, and the network node 110 may receive, an ACK 620 indicating that the UE 120 successfully decoded the TB associated with HARQ ID=x and NDI=1.

As shown in FIG. 6A, DCIs 605a, 605b, 605c, and 605d may indicate whether continuous rate matching is activated and an RV ID. For example, the DCIs 605 may include an RV ID field, where a first bit of the RV ID field may indicate whether continuous rate matching is activated (e.g., continuous rate matching (CRM)=1 or 0), and a second set of bits of the RV ID field may indicate the RV ID. For example, as shown in FIG. 6B, if the CRM=1, then the UE 120 determines that the associated HARQ transmission/retransmission is in accordance with continuous rate matching, and the UE 120 determines that the set of bits associated with the RV ID may be ignored (e.g., RV ID=Null). The DCI 605a may indicate CRM=1, and therefore the UE 120 may determine to store the coded bits of data packet 610a at the circular buffer in accordance with continuous rate matching. Additionally, the DCI 605a may indicate an explicit value for the MCS associated with data packet 610a (e.g., rather than a reserved MCS). The DCI 605b may indicate CRM=1, and therefore the UE 120 may determine to store the coded bits of data packet 610b at the circular buffer, directly after the coded bits of data packet 610a, in accordance with continuous rate matching. Additionally, the DCI 605b may indicate reserved MCS associated with data packet 610b. The DCI 605c may indicate CRM=1; however, as shown in FIG. 6B, the UE 120 may be unable to receive the DCI 605c. Based on the UE 120 not receiving the DCI 605c, the network node 110 may indicate in DCI 605d that continuous rate matching is disabled and HARQ RV ID is enabled. For example, the DCI 605d may indicate CRM=0 and RV ID=3, and therefore the UE 120 may determine to store the coded bits of data packet 610c to the circular buffer at an indicated point of the circular buffer associated with RV ID=3. Additionally, the DCI 605d may indicate a reserved MCS associated with data packet 610c. In accordance with example 600B, the UE 120 may be able to perform soft-combining of the coded bits of data packets 610a, 610b, and 610c and successfully decode the associated TB. Therefore, the UE 120 may transmit, and the network node 110 may receive, the ACK 620 indicating that the UE 120 successfully decoded the TB associated with HARQ ID=x and NDI=1.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with continuous rate matching for hybrid automatic repeat request retransmission.

As shown in FIG. 7, in some aspects, process 700 may include receiving, from a network node, first control information that schedules an initial transmission of a transport block associated with a HARQ process (block 710). For example, the UE (e.g., using reception component 902 and/or communication manager 906, depicted in FIG. 9) may receive, from a network node, first control information that schedules an initial transmission of a transport block associated with a HARQ process, as described above.

As further shown in FIG. 7, in some aspects, process 700 may include receiving, from the network node, second control information that schedules a retransmission of the transport block based at least in part on the initial transmission of the transport block being associated with a HARQ NACK indication (block 720). For example, the UE (e.g., using reception component 902 and/or communication manager 906, depicted in FIG. 9) may receive, from the network node, second control information that schedules a retransmission of the transport block based at least in part on the initial transmission of the transport block being associated with a HARQ NACK indication, as described above.

As further shown in FIG. 7, in some aspects, process 700 may include communicating, with the network node, the retransmission of the transport block in accordance with a continuous rate matching mode based at least in part on one or more conditions (block 730). For example, the UE (e.g., using reception component 902, transmission component 904, and/or communication manager 906, depicted in FIG. 9) may communicate, with the network node, the retransmission of the transport block in accordance with a continuous rate matching mode based at least in part on one or more conditions, as described above.

Process 700 may include additional aspects, such as any single aspect or any combination of aspects described below and/or in connection with one or more other processes described elsewhere herein.

In a first aspect, the one or more conditions comprise the second control information indicating a reserved modulation and coding scheme (MCS) for the retransmission of the transport block.

In a second aspect, alone or in combination with the first aspect, the one or more conditions associated with the HARQ process comprise successful reception of the first control information.

In a third aspect, alone or in combination with one or more of the first and second aspects, process 700 includes transmitting, to the network node, capability information that indicates support to operate in accordance with the continuous rate matching mode, where the one or more conditions comprise transmission of the capability information.

In a fourth aspect, alone or in combination with one or more of the first through third aspects, process 700 includes receiving, prior to reception of the first control information, signaling enabling the continuous rate matching mode for communication of retransmissions, where the one or more conditions comprise reception of the signaling enabling the continuous rate matching mode.

In a fifth aspect, alone or in combination with one or more of the first through fourth aspects, the signaling is an RRC parameter or a MAC-CE activation indication.

In a sixth aspect, alone or in combination with one or more of the first through fifth aspects, the one or more conditions comprise the second control information including an RV identifier field that indicates a first value indicating communication of the retransmission in accordance with the continuous rate matching mode.

In a seventh aspect, alone or in combination with one or more of the first through sixth aspects, process 700 includes receiving, from the network node, third control information that schedules a second retransmission of the transport block, where the third control information includes an RV identifier field with a second value indicating communication of the second retransmission in accordance with a HARQ RV identifier scheme.

In an eighth aspect, alone or in combination with one or more of the first through seventh aspects, the first value is a first RV identifier that indicates operations in accordance with the continuous rate matching mode and the second value is one of a set of RV identifiers that indicate operations in accordance with the HARQ RV identifier scheme.

In a ninth aspect, alone or in combination with one or more of the first through eighth aspects, a first bit included in the RV identifier field indicates the first value or the second value, and an additional set of bits included in the RV identifier field indicate an RV identifier.

In a tenth aspect, alone or in combination with one or more of the first through ninth aspects, the transport block is an uplink transport block, and communicating the transport block in accordance with the continuous rate matching mode comprises encoding the retransmission of the transport block in accordance with a second portion of a codeword stored in a circular buffer, where the second portion of the codeword is directly subsequent to a first portion of the codeword stored in the circular buffer, the first portion of the codeword associated with encoding the initial transmission of the transport block, and transmitting, to the network node, the retransmission of the transport block based at least in part on encoding the retransmission of the transport block.

In an eleventh aspect, alone or in combination with one or more of the first through tenth aspects, the transport block is a downlink transport block, and communicating the transport block in accordance with the continuous rate matching mode comprises receiving, from the network node, the retransmission of the transport block, and decoding the transport block in accordance with a second portion of a codeword associated with the transport block, where the second portion of the codeword is directly subsequent to a first portion of the codeword in a circular buffer, and the first portion of the codeword is associated with the initial transmission of the transport block.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with continuous rate matching for hybrid automatic repeat request retransmission.

As shown in FIG. 8, in some aspects, process 800 may include transmitting, to a UE, first control information that schedules an initial transmission of a transport block associated with a HARQ process (block 810). For example, the network node (e.g., using transmission component 1004 and/or communication manager 1006, depicted in FIG. 10) may transmit, to a UE, first control information that schedules an initial transmission of a transport block associated with a HARQ process, as described above.

As further shown in FIG. 8, in some aspects, process 800 may include transmitting, to the UE, second control information that schedules a retransmission of the transport block based at least in part on the initial transmission of the transport block being associated with a HARQ NACK indication (block 820). For example, the network node (e.g., using transmission component 1004 and/or communication manager 1006, depicted in FIG. 10) may transmit, to the UE, second control information that schedules a retransmission of the transport block based at least in part on the initial transmission of the transport block being associated with a HARQ NACK indication, as described above.

As further shown in FIG. 8, in some aspects, process 800 may include communicating, with the UE, the retransmission of the transport block in accordance with a continuous rate matching mode based at least in part on one or more conditions (block 830). For example, the network node (e.g., using reception component 1002, transmission component 1004, and/or communication manager 1006, depicted in FIG. 10) may communicate, with the UE, the retransmission of the transport block in accordance with a continuous rate matching mode based at least in part on one or more conditions, as described above.

Process 800 may include additional aspects, such as any single aspect or any combination of aspects described below and/or in connection with one or more other processes described elsewhere herein.

In a first aspect, the one or more conditions comprise the second control information indicating a reserved MCS for the retransmission of the transport block.

In a second aspect, alone or in combination with the first aspect, process 800 includes receiving, from the UE, capability information that indicates support to operate in accordance with the continuous rate matching mode, where the one or more conditions comprise reception of the capability information.

In a third aspect, alone or in combination with one or more of the first and second aspects, process 800 includes transmitting, prior to reception of the first control information, signaling enabling the continuous rate matching mode for communication of retransmissions, where the one or more conditions comprise transmission of the signaling enabling the continuous rate matching mode.

In a fourth aspect, alone or in combination with one or more of the first through third aspects, the signaling is an RRC parameter or a MAC-CE activation indication.

In a fifth aspect, alone or in combination with one or more of the first through fourth aspects, the one or more conditions comprise the second control information including an RV identifier field that indicates a first value indicating communication of the retransmission in accordance with the continuous rate matching mode.

In a sixth aspect, alone or in combination with one or more of the first through fifth aspects, the UE fails to receive third control information that schedules a second retransmission of the transport block, and process 800 includes transmitting, to the UE, fourth control information that schedules a third retransmission of the transport block, where the RV identifier field includes a second value indicating communication of the third retransmission in accordance with a HARQ RV identifier scheme based at least in part on the UE failing to receive the third control information.

In a seventh aspect, alone or in combination with one or more of the first through sixth aspects, the first value is a first RV identifier that indicates operations in accordance with the continuous rate matching mode and the second value is one of a set of RV identifiers that indicate operations in accordance with the HARQ RV identifier scheme.

In an eighth aspect, alone or in combination with one or more of the first through seventh aspects, a first bit included in the RV identifier field indicates the first value or the second value, and an additional set of bits included in the RV identifier field indicate an RV identifier.

In a ninth aspect, alone or in combination with one or more of the first through eighth aspects, the transport block is a downlink transport block, and communicating the transport block in accordance with the continuous rate matching mode comprises encoding the retransmission of the transport block in accordance with a second portion of a codeword stored in a circular buffer, where the second portion of the codeword is directly subsequent to a first portion of the codeword stored in the circular buffer, the first portion of the codeword associated with encoding the initial transmission of the transport block, and transmitting, to the UE, the retransmission of the transport block based at least in part on encoding the retransmission of the transport block.

In a tenth aspect, alone or in combination with one or more of the first through ninth aspects, the transport block is an uplink transport block, and communicating the transport block in accordance with the continuous rate matching mode comprises receiving, from the UE, the retransmission of the transport block, and decoding the transport block in accordance with a second portion of a codeword associated with the transport block, where the second portion of the codeword is directly subsequent to a first portion of the codeword in a circular buffer, and the first portion of the codeword is associated with the initial transmission of the transport block.

In an eleventh aspect, alone or in combination with one or more of the first through tenth aspects, process 800 includes receiving, from the UE via an uplink channel, the initial transmission of the transport block, where the network node successfully detects an uplink demodulated reference signal (DMRS) via the uplink channel, and transmitting, as part of the second control information, an indication for the UE to retransmit the transport block in accordance with the continuous rate matching mode based at least in part on successful detection of the uplink DMRS.

In a twelfth aspect, alone or in combination with one or more of the first through eleventh aspects, process 800 includes receiving, from the UE, the HARQ NACK indication that indicates unsuccessful decoding of the initial transmission of the transport block, where the HARQ NACK indication is associated with a signal quality that satisfies a threshold, and transmitting, as part of the second control information, an indication for the UE that retransmission of the transport block is in accordance with the continuous rate matching mode based at least in part on the signal quality satisfying the threshold.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3 through 6B. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a network node, first control information that schedules an initial transmission of a transport block associated with a HARQ process. The reception component 902 may receive, from the network node, second control information that schedules a retransmission of the transport block based at least in part on the initial transmission of the transport block being associated with a HARQ NACK indication. The reception component 902 and/or the transmission component 904 may communicate, with the network node, the retransmission of the transport block in accordance with a continuous rate matching mode based at least in part on one or more conditions.

The transmission component 904 may transmit, to the network node, capability information that indicates support to operate in accordance with the continuous rate matching mode, wherein the one or more conditions comprise transmission of the capability information.

The reception component 902 may receive, prior to reception of the first control information, signaling enabling the continuous rate matching mode for communication of retransmissions, where the one or more conditions comprise reception of the signaling enabling the continuous rate matching mode.

The reception component 902 may receive, from the network node, third control information that schedules a second retransmission of the transport block, wherein the third control information includes an RV identifier field with a second value indicating communication of the second retransmission in accordance with a HARQ RV identifier scheme.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3 through 6B. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a UE, first control information that schedules an initial transmission of a transport block associated with a HARQ process. The transmission component 1004 may transmit, to the UE, second control information that schedules a retransmission of the transport block based at least in part on the initial transmission of the transport block being associated with a HARQ NACK indication. The reception component 1002 and/or the transmission component 1004 may communicate, with the UE, the retransmission of the transport block in accordance with a continuous rate matching mode based at least in part on one or more conditions.

The reception component 1002 may receive, from the UE, capability information that indicates support to operate in accordance with the continuous rate matching mode, where the one or more conditions comprise reception of the capability information.

The transmission component 1004 may transmit, prior to reception of the first control information, signaling enabling the continuous rate matching mode for communication of retransmissions, where the one or more conditions comprise transmission of the signaling enabling the continuous rate matching mode.

The reception component 1002 may receive, from the UE via an uplink channel, the initial transmission of the transport block, where the network node successfully detects an uplink DMRS via the uplink channel.

The transmission component 1004 may transmit, as part of the second control information, an indication for the UE to retransmit the transport block in accordance with the continuous rate matching mode based at least in part on successful detection of the uplink DMRS.

The reception component 1002 may receive, from the UE, the HARQ NACK indication that indicates unsuccessful decoding of the initial transmission of the transport block, where the HARQ NACK indication is associated with a signal quality that satisfies a threshold.

The transmission component 1004 may transmit, as part of the second control information, an indication for the UE that retransmission of the transport block is in accordance with the continuous rate matching mode based at least in part on the signal quality satisfying the threshold.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving, from a network node, first control information that schedules an initial transmission of a transport block associated with a hybrid automatic repeat request (HARQ) process; receiving, from the network node, second control information that schedules a retransmission of the transport block based at least in part on the initial transmission of the transport block being associated with a HARQ negative acknowledgement (NACK) indication; and communicating, with the network node, the retransmission of the transport block in accordance with a continuous rate matching mode based at least in part on one or more conditions.

Aspect 2: The method of Aspect 1, wherein the one or more conditions comprise the second control information indicating a reserved modulation and coding scheme (MCS) for the retransmission of the transport block.

Aspect 3: The method of any of Aspects 1-2, wherein the one or more conditions associated with the HARQ process comprise successful reception of the first control information.

Aspect 4: The method of any of Aspects 1-3, further comprising: transmitting, to the network node, capability information that indicates support to operate in accordance with the continuous rate matching mode, wherein the one or more conditions comprise transmission of the capability information.

Aspect 5: The method of any of Aspects 1-4, further comprising: receiving, prior to reception of the first control information, signaling enabling the continuous rate matching mode for communication of retransmissions, wherein the one or more conditions comprise reception of the signaling enabling the continuous rate matching mode.

Aspect 6: The method of Aspect 5, wherein the signaling is a radio resource control (RRC) parameter or a medium access control-control element (MAC-CE) activation indication.

Aspect 7: The method of any of Aspects 1-6, wherein the one or more conditions comprise the second control information including a redundancy version (RV) identifier field that indicates a first value indicating communication of the retransmission in accordance with the continuous rate matching mode.

Aspect 8: The method of Aspect 7, further comprising: receiving, from the network node, third control information that schedules a second retransmission of the transport block, wherein the third control information includes an RV identifier field with a second value indicating communication of the second retransmission in accordance with a HARQ RV identifier scheme.

Aspect 9: The method of Aspect 8, wherein the first value is a first RV identifier that indicates operations in accordance with the continuous rate matching mode and the second value is one of a set of RV identifiers that indicate operations in accordance with the HARQ RV identifier scheme.

Aspect 10: The method of Aspect 8, wherein a first bit included in the RV identifier field indicates the first value or the second value, and wherein an additional set of bits included in the RV identifier field indicate an RV identifier.

Aspect 11: The method of any of Aspects 1-10, wherein the transport block is an uplink transport block, and wherein communicating the transport block in accordance with the continuous rate matching mode comprises: encoding the retransmission of the transport block in accordance with a second portion of a codeword stored in a circular buffer, wherein the second portion of the codeword is directly subsequent to a first portion of the codeword stored in the circular buffer, the first portion of the codeword associated with encoding the initial transmission of the transport block; and transmitting, to the network node, the retransmission of the transport block based at least in part on encoding the retransmission of the transport block.

Aspect 12: The method of any of Aspects 1-11, wherein the transport block is a downlink transport block, and wherein communicating the transport block in accordance with the continuous rate matching mode comprises: receiving, from the network node, the retransmission of the transport block; and decoding the transport block in accordance with a second portion of a codeword associated with the transport block, wherein the second portion of the codeword is directly subsequent to a first portion of the codeword in a circular buffer, and wherein the first portion of the codeword is associated with the initial transmission of the transport block.

Aspect 13: A method of wireless communication performed by a network node, comprising: transmitting, to a user equipment (UE), first control information that schedules an initial transmission of a transport block associated with a hybrid automatic repeat request (HARQ) process; transmitting, to the UE, second control information that schedules a retransmission of the transport block based at least in part on the initial transmission of the transport block being associated with a HARQ negative acknowledgement (NACK) indication; and communicating, with the UE, the retransmission of the transport block in accordance with a continuous rate matching mode based at least in part on one or more conditions.

Aspect 14: The method of Aspect 13, wherein the one or more conditions comprise the second control information indicating a reserved modulation and coding scheme (MCS) for the retransmission of the transport block.

Aspect 15: The method of any of Aspects 13-14, further comprising: receiving, from the UE, capability information that indicates support to operate in accordance with the continuous rate matching mode, wherein the one or more conditions comprise reception of the capability information.

Aspect 16: The method of any of Aspects 13-15, further comprising: transmitting, prior to reception of the first control information, signaling enabling the continuous rate matching mode for communication of retransmissions, wherein the one or more conditions comprise transmission of the signaling enabling the continuous rate matching mode.

Aspect 17: The method of Aspect 16, wherein the signaling is a radio resource control (RRC) parameter or a medium access control-control element (MAC-CE) activation indication.

Aspect 18: The method of any of Aspects 13-17, wherein the one or more conditions comprise the second control information including a redundancy version (RV) identifier field that indicates a first value indicating communication of the retransmission in accordance with the continuous rate matching mode.

Aspect 19: The method of Aspect 18, wherein the UE fails to receive third control information that schedules a second retransmission of the transport block, the method further comprising: transmitting, to the UE, fourth control information that schedules a third retransmission of the transport block, wherein the RV identifier field includes a second value indicating communication of the third retransmission in accordance with a HARQ RV identifier scheme based at least in part on the UE failing to receive the third control information.

Aspect 20: The method of Aspect 19, wherein the first value is a first RV identifier that indicates operations in accordance with the continuous rate matching mode and the second value is one of a set of RV identifiers that indicate operations in accordance with the HARQ RV identifier scheme.

Aspect 21: The method of Aspect 19, wherein a first bit included in the RV identifier field indicates the first value or the second value, and wherein an additional set of bits included in the RV identifier field indicate an RV identifier.

Aspect 22: The method of any of Aspects 13-21, wherein the transport block is a downlink transport block, and wherein communicating the transport block in accordance with the continuous rate matching mode comprises: encoding the retransmission of the transport block in accordance with a second portion of a codeword stored in a circular buffer, wherein the second portion of the codeword is directly subsequent to a first portion of the codeword stored in the circular buffer, the first portion of the codeword associated with encoding the initial transmission of the transport block; and transmitting, to the UE, the retransmission of the transport block based at least in part on encoding the retransmission of the transport block.

Aspect 23: The method of any of Aspects 13-22, wherein the transport block is an uplink transport block, and wherein communicating the transport block in accordance with the continuous rate matching mode comprises: receiving, from the UE, the retransmission of the transport block; and decoding the transport block in accordance with a second portion of a codeword associated with the transport block, wherein the second portion of the codeword is directly subsequent to a first portion of the codeword in a circular buffer, and wherein the first portion of the codeword is associated with the initial transmission of the transport block.

Aspect 24: The method of any of Aspects 13-23, further comprising: receiving, from the UE via an uplink channel, the initial transmission of the transport block, wherein the network node successfully detects an uplink demodulated reference signal (DMRS) via the uplink channel; and transmitting, as part of the second control information, an indication for the UE to retransmit the transport block in accordance with the continuous rate matching mode based at least in part on successful detection of the uplink DMRS.

Aspect 25: The method of any of Aspects 13-24, further comprising: receiving, from the UE, the HARQ NACK indication that indicates unsuccessful decoding of the initial transmission of the transport block, wherein the HARQ NACK indication is associated with a signal quality that satisfies a threshold; and transmitting, as part of the second control information, an indication for the UE that retransmission of the transport block is in accordance with the continuous rate matching mode based at least in part on the signal quality satisfying the threshold.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, first control information that schedules an initial transmission of a transport block associated with a hybrid automatic repeat request (HARQ) process;
receive, from the network node, second control information that schedules a retransmission of the transport block based at least in part on the initial transmission of the transport block being associated with a HARQ negative acknowledgement (NACK) indication; and
communicate, with the network node, the retransmission of the transport block in accordance with a continuous rate matching mode based at least in part on one or more conditions.

2. The UE of claim 1, wherein the one or more conditions comprise the second control information indicating a reserved modulation and coding scheme (MCS) for the retransmission of the transport block.

3. The UE of claim 1, wherein the one or more conditions associated with the HARQ process comprise successful reception of the first control information.

4. The UE of claim 1, wherein the one or more processors are further configured to cause the UE to:
transmit, to the network node, capability information that indicates support to operate in accordance with the continuous rate matching mode, wherein the one or more conditions comprise transmission of the capability information.

5. The UE of claim 1, wherein the one or more processors are further configured to cause the UE to:
receive, prior to reception of the first control information, signaling enabling the continuous rate matching mode for communication of retransmissions, wherein the one or more conditions comprise reception of the signaling enabling the continuous rate matching mode.

6. The UE of claim 5, wherein the signaling is a radio resource control (RRC) parameter or a medium access control-control element (MAC-CE) activation indication.

7. The UE of claim 1, wherein the one or more conditions comprise the second control information including a redundancy version (RV) identifier field that indicates a first value indicating communication of the retransmission in accordance with the continuous rate matching mode.

8. The UE of claim 7, wherein the one or more processors are further configured to cause the UE to:
receive, from the network node, third control information that schedules a second retransmission of the transport block, wherein the third control information includes an RV identifier field with a second value indicating communication of the second retransmission in accordance with a HARQ RV identifier scheme.

9. The UE of claim 8, wherein the first value is a first RV identifier that indicates operations in accordance with the continuous rate matching mode and the second value is one of a set of RV identifiers that indicate operations in accordance with the HARQ RV identifier scheme.

10. The UE of claim 8, wherein a first bit included in the RV identifier field indicates the first value or the second value, and wherein an additional set of bits included in the RV identifier field indicate an RV identifier.

11. The UE of claim 1, wherein the transport block is an uplink transport block, and wherein communicating the transport block in accordance with the continuous rate matching mode comprises:
encode the retransmission of the transport block in accordance with a second portion of a codeword stored in a circular buffer, wherein the second portion of the codeword is directly subsequent to a first portion of the codeword stored in the circular buffer, the first portion of the codeword associated with encoding the initial transmission of the transport block; and
transmit, to the network node, the retransmission of the transport block based at least in part on encoding the retransmission of the transport block.

12. The UE of claim 1, wherein the transport block is a downlink transport block, and wherein communicating the transport block in accordance with the continuous rate matching mode comprises:
receive, from the network node, the retransmission of the transport block; and
decode the transport block in accordance with a second portion of a codeword associated with the transport block, wherein the second portion of the codeword is directly subsequent to a first portion of the codeword in a circular buffer, and wherein the first portion of the codeword is associated with the initial transmission of the transport block.

13. A network node for wireless communication, comprising:
one or more memories; and
one or more processors, coupled to the one or more memories, configured to cause the network node to:
transmit, to a user equipment (UE), first control information that schedules an initial transmission of a transport block associated with a hybrid automatic repeat request (HARQ) process;
transmit, to the UE, second control information that schedules a retransmission of the transport block based at least in part on the initial transmission of the transport block being associated with a HARQ negative acknowledgement (NACK) indication; and
communicate, with the UE, the retransmission of the transport block in accordance with a continuous rate matching mode based at least in part on one or more conditions.

14. The network node of claim 13, wherein the one or more conditions comprise the second control information indicating a reserved modulation and coding scheme (MCS) for the retransmission of the transport block.

15. The network node of claim 13, wherein the one or more processors are further configured to cause the network node to:
receive, from the UE, capability information that indicates support to operate in accordance with the continuous rate matching mode, wherein the one or more conditions comprise reception of the capability information.

16. The network node of claim 13, wherein the one or more processors are further configured to cause the network node to:
transmit, prior to reception of the first control information, signaling enabling the continuous rate matching mode for communication of retransmissions, wherein the one or more conditions comprise transmission of the signaling enabling the continuous rate matching mode.

17. The network node of claim 16, wherein the signaling is a radio resource control (RRC) parameter or a medium access control-control element (MAC-CE) activation indication.

18. The network node of claim 13, wherein the one or more conditions comprise the second control information including a redundancy version (RV) identifier field that indicates a first value indicating communication of the retransmission in accordance with the continuous rate matching mode.

19. The network node of claim 18, wherein the one or more processors are configured to cause the network node to identify that the UE fails to receive third control information that schedules a second retransmission of the transport block, and wherein the one or more processors are further configured to cause the network node to:
transmit, to the UE, fourth control information that schedules a third retransmission of the transport block, wherein the RV identifier field includes a second value indicating communication of the third retransmission in accordance with a HARQ RV identifier scheme based at least in part on the UE failing to receive the third control information.

20. The network node of claim 19, wherein the first value is a first RV identifier that indicates operations in accordance with the continuous rate matching mode and the second value is one of a set of RV identifiers that indicate operations in accordance with the HARQ RV identifier scheme.

21. The network node of claim 19, wherein a first bit included in the RV identifier field indicates the first value or the second value, and wherein an additional set of bits included in the RV identifier field indicate an RV identifier.

22. The network node of claim 13, wherein the transport block is a downlink transport block, and wherein communicating the transport block in accordance with the continuous rate matching mode comprises:
encode the retransmission of the transport block in accordance with a second portion of a codeword stored in a circular buffer, wherein the second portion of the codeword is directly subsequent to a first portion of the codeword stored in the circular buffer, the first portion of the codeword associated with encoding the initial transmission of the transport block; and
transmit, to the UE, the retransmission of the transport block based at least in part on encoding the retransmission of the transport block.

23. The network node of claim 13, wherein the transport block is an uplink transport block, and wherein communicating the transport block in accordance with the continuous rate matching mode comprises:
receive, from the UE, the retransmission of the transport block; and
decode the transport block in accordance with a second portion of a codeword associated with the transport block, wherein the second portion of the codeword is directly subsequent to a first portion of the codeword in a circular buffer, and wherein the first portion of the codeword is associated with the initial transmission of the transport block.

24. The network node of claim 13, wherein the one or more processors are further configured to cause the network node to:
receive, from the UE via an uplink channel, the initial transmission of the transport block, wherein the one or more processors are configured to cause the network node to successfully detect an uplink demodulated reference signal (DMRS) via the uplink channel; and
transmit, as part of the second control information, an indication for the UE to retransmit the transport block in accordance with the continuous rate matching mode based at least in part on successful detection of the uplink DMRS.

25. The network node of claim 13, wherein the one or more processors are further configured to cause the network node to:
receive, from the UE, the HARQ NACK indication that indicates unsuccessful decoding of the initial transmission of the transport block, wherein the HARQ NACK indication is associated with a signal quality that satisfies a threshold; and
transmit, as part of the second control information, an indication for the UE that retransmission of the transport block is in accordance with the continuous rate matching mode based at least in part on the signal quality satisfying the threshold.

26. A method of wireless communication performed by a user equipment (UE), comprising:
receiving, from a network node, first control information that schedules an initial transmission of a transport block associated with a hybrid automatic repeat request (HARQ) process;
receiving, from the network node, second control information that schedules a retransmission of the transport block based at least in part on the initial transmission of the transport block being associated with a HARQ negative acknowledgement (NACK) indication; and
communicating, with the network node, the retransmission of the transport block in accordance with a continuous rate matching mode based at least in part on one or more conditions.

27. The method of claim 26, wherein the one or more conditions comprise the second control information indicating a reserved modulation and coding scheme (MCS) for the retransmission of the transport block.

28. The method of claim 26, wherein the one or more conditions associated with the HARQ process comprise successful reception of the first control information.

29. The method of claim 26, further comprising:
transmitting, to the network node, capability information that indicates support to operate in accordance with the continuous rate matching mode, wherein the one or more conditions comprise transmission of the capability information.

30. A method of wireless communication performed by a network node, comprising:
transmitting, to a user equipment (UE), first control information that schedules an initial transmission of a transport block associated with a hybrid automatic repeat request (HARQ) process;
transmitting, to the UE, second control information that schedules a retransmission of the transport block based at least in part on the initial transmission of the transport block being associated with a HARQ negative acknowledgement (NACK) indication; and
communicating, with the UE, the retransmission of the transport block in accordance with a continuous rate matching mode based at least in part on one or more conditions.
